(19) United States
(12) Patent Application Publication
(10) Pub. No.: US 2019/0369371 A1
(43) Pub. Date: Dec. 5, 2019

(54) ZOOM LENS AND IMAGING APPARATUS

(71) Applicant: SONY CORPORATION, TOKYO (JP)

(72) Inventors: Kouji KATOU, SAITAMA (JP); Hiromichi NOSE, KANAGAWA (JP)

(21) Appl. No.: 16/478,220

(22) PCT Filed: Dec. 27, 2017
(86) PCT No.: PCT/JP2017/046864

§ 371 Date: Jul. 16, 2019

(30) Foreign Application Priority Data
Jan. 25, 2017 (JP) 2017-011423

(51) Int. Cl. G02B 15/14; G02B 15/20; G02B 13/18

(52) U.S. Cl. CPC G02B 15/145515; G02B 13/18; G02B 15/20

(57) ABSTRACT

A zoom lens of the present disclosure includes, in order from an object side toward an image plane side, a first lens group having negative refractive power, a second lens group having positive refractive power, a third lens group having positive refractive power, a fourth lens group having positive or negative refractive power, and a fifth lens group having negative refractive power. Intervals between the respective lens groups are changed upon zooming from a wide angle end to a telephoto end. Focusing is performed by causing the second lens group and the fourth lens group to travel upon changing of a subject distance from infinity to proximity.

### TECHNICAL FIELD

The present disclosure relates to a zoom lens and an imaging apparatus.

### BACKGROUND ART

As a zoom lens focus system, a front focus system is common that extends a first lens group as it is. Recently, however, there has been a strong demand for an optical system, for use in imaging equipment such as a single-lens reflex camera, to have high performance as well as fast autofocusing. Accordingly, an inner focus system that performs focusing using a light-weight lens group other than a first lens group has become a mainstream.

### CITATION LIST

### Patent Literature

PTL 1: Japanese Unexamined Patent Application Publication No. 2009-175509

PTL 2: Japanese Unexamined Patent Application Publication No. 2015-203734

### SUMMARY OF THE INVENTION

Further, for a mirror-lens single reflex camera, an inner focus system has been developed that is designed to constantly keep determining a focus-driving direction by keeping moving a focus lens group slightly along an optical axis. When an image height change rate is large upon focusing using this system, magnification variation of a subject is recognized, which results in giving a sense of obtrusiveness. It is thus requested to have a smaller image height change rate upon focus-driving.

It is desirable to provide a zoom lens having a favorable image-forming performance from infinity to proximity, and an imaging apparatus mounted with such a zoom lens.

A zoom lens according to one embodiment of the present disclosure includes, in order from an object side toward an image plane side, a first lens group having negative refractive power, a second lens group having positive refractive power, a third lens group having positive refractive power, a fourth lens group having positive or negative refractive power, and a fifth lens group having negative refractive power. Intervals between the respective lens groups are changed upon zooming from a wide angle end to a telephoto end. Focusing is performed by causing the second lens group and the fourth lens group to travel upon changing of a subject distance from infinity to proximity.

An imaging apparatus according to one embodiment of the present disclosure includes a zoom lens, and an imaging device that outputs an imaging signal corresponding to an optical image formed by the zoom lens, and the zoom lens is configured by the above-described zoom lens according to one embodiment of the present disclosure.

In the zoom lens or the imaging apparatus according to one embodiment of the present disclosure, intervals between the respective lens groups are changed upon zooming from a wide angle end to a telephoto end, and focusing is performed by causing the second lens group and the fourth lens group to travel upon changing of a subject distance from infinity to proximity.

According to the zoom lens or the imaging apparatus of one embodiment of the present disclosure, optimization of a configuration of each of the lens groups is achieved in the zoom lens system having the five-group configuration as a whole, to perform focusing by causing the second lens group and the fourth lens group to travel upon changing of the subject distance from infinity to proximity, thus making it possible to achieve a favorable image-forming performance from infinity to proximity.

It is to be noted that effects described here are not necessarily limiting. An effect may be any of effects described in the present disclosure.

### BRIEF DESCRIPTION OF DRAWINGS

FIG. 1 is a lens cross-sectional view of a first configuration example of a zoom lens according to one embodiment of the present disclosure.

FIG. 2 is an aberration diagram illustrating various aberrations at a wide angle end in Numerical Working Example 1 in which specific numerical values are applied to the zoom lens illustrated in FIG. 1.

FIG. 3 is an aberration diagram illustrating various aberrations at an intermediate focal distance in Numerical Working Example 1 in which specific numerical values are applied to the zoom lens illustrated in FIG. 1.

FIG. 4 is an aberration diagram illustrating various aberrations at a telephoto end in Numerical Working Example 1 in which specific numerical values are applied to the zoom lens illustrated in FIG. 1.

FIG. 5 is a lens cross-sectional view of a second configuration example of the zoom lens.

FIG. 6 is an aberration diagram illustrating various aberrations at a wide angle end in Numerical Working Example 2 in which specific numerical values are applied to the zoom lens illustrated in FIG. 5.

FIG. 7 is an aberration diagram illustrating various aberrations at an intermediate focal distance in Numerical Working Example 2 in which specific numerical values are applied to the zoom lens illustrated in FIG. 5.

FIG. 8 is an aberration diagram illustrating various aberrations at a telephoto end in Numerical Working Example 2 in which specific numerical values are applied to the zoom lens illustrated in FIG. 5.

FIG. 9 is a lens cross-sectional view of a third configuration example of the zoom lens.

FIG. 10 is an aberration diagram illustrating various aberrations at a wide angle end in Numerical Working Example 3 in which specific numerical values are applied to the zoom lens illustrated in FIG. 9.

FIG. 11 is an aberration diagram illustrating various aberrations at an intermediate focal distance in Numerical Working Example 3 in which specific numerical values are applied to the zoom lens illustrated in FIG. 9.

FIG. 12 is an aberration diagram illustrating various aberrations at a telephoto end in Numerical Working Example 3 in which specific numerical values are applied to the zoom lens illustrated in FIG. 9.

FIG. 13 is a lens cross-sectional view of a fourth configuration example of the zoom lens.

FIG. 14 is an aberration diagram illustrating various aberrations at a wide angle end in Numerical Working Example 4 in which specific numerical values are applied to the zoom lens illustrated in FIG. 13.

FIG. 15 is an aberration diagram illustrating various aberrations at an intermediate focal distance in Numerical Working Example 4 in which specific numerical values are applied to the zoom lens illustrated in FIG. 13.

FIG. 16 is an aberration diagram illustrating various aberrations at a telephoto end in Numerical Working Example 4 in which specific numerical values are applied to the zoom lens illustrated in FIG. 13.

FIG. 17 is a lens cross-sectional view of a fifth configuration example of the zoom lens.

FIG. 18 is an aberration diagram illustrating various aberrations at a wide angle end in Numerical Working Example 5 in which specific numerical values are applied to the zoom lens illustrated in FIG. 17.

FIG. 19 is an aberration diagram illustrating various aberrations at an intermediate focal distance in Numerical Working Example 5 in which specific numerical values are applied to the zoom lens illustrated in FIG. 17.

FIG. 20 is an aberration diagram illustrating various aberrations at a telephoto end in Numerical Working Example 5 in which specific numerical values are applied to the zoom lens illustrated in FIG. 17.

FIG. 21 is a block diagram illustrating a configuration example of an imaging apparatus.

### MODES FOR CARRYING OUT THE INVENTION

In the following, embodiments of the present disclosure are described in detail with reference to the drawings. It is to be noted that the description is given in the following order.

### 0. Comparative Example

### 1. Basic Configuration of Lenses

### 2. Workings and Effects

### 3. Example of Application to Imaging Apparatus

### 4. Numerical Working Examples of Lenses

### 5. Other Embodiments

### 0. Comparative Example

The present disclosure relates to an optical system suitable for an imaging lens for use in an imaging apparatus such as a single-lens reflex camera or a video camera. In particular, the present disclosure relates to a wide angle zoom lens that adopts an inner focus system suitable for an autofocus camera and has a small image height change rate upon moving a focus lens group slightly in a direction along an optical axis. The wide angle zoom lens makes it possible to achieve a large diameter of a maximum aperture F number of about F2.8.

A zoom lens disclosed in PTL 1 (Japanese Unexamined Patent Application Publication No. 2009-175509) adopts the inner focus system that performs focusing using a lens group immediately in front of an aperture upon changing from infinity to proximity. Although aberration variation upon focusing is reduced to a certain degree in this system, the zoom lens has a heavy weight and is not suitable for quick autofocusing that is applicable to a video camera system designed to capture a moving image, in particular, among recent camera systems. Further, the image height change rate is large, and thus magnification variation of a subject results in being recognized.

A zoom lens disclosed in PTL 2 (Japanese Unexamined Patent Application Publication No. 2015-203734) performs focusing using a single lens, and is thus directed to addressing the quick autofocusing that is applicable to the video camera system designed to capture a moving image. The zoom lens, however, has large aberration variation upon changing to proximity, and thus has not undergone sufficient aberration correction. Further, the zoom lens has a maximum aperture F number of 5.6 and is dark, and thus fails to have a larger diameter.

It is thus requested to develop a large-diameter zoom lens that adopts a floating system and has a favorable image-forming performance from infinity to proximity.

### 1. Basic Configuration of Lenses

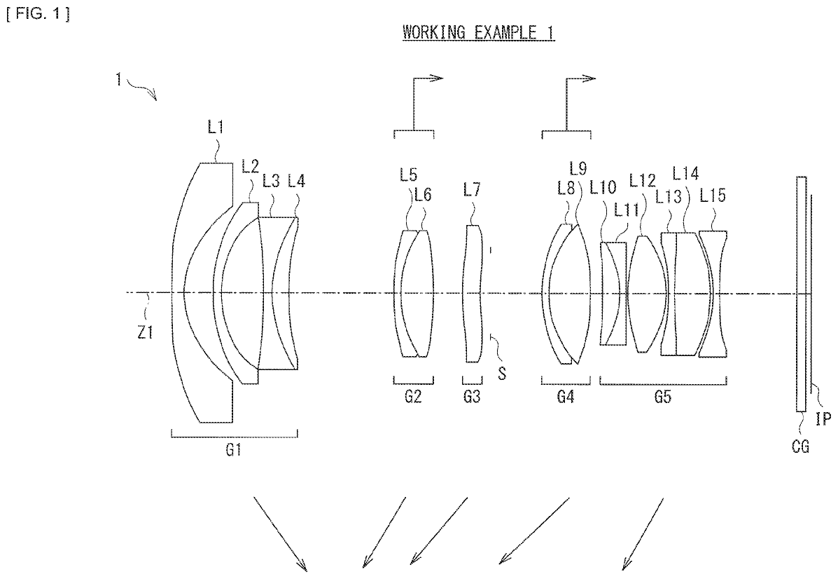

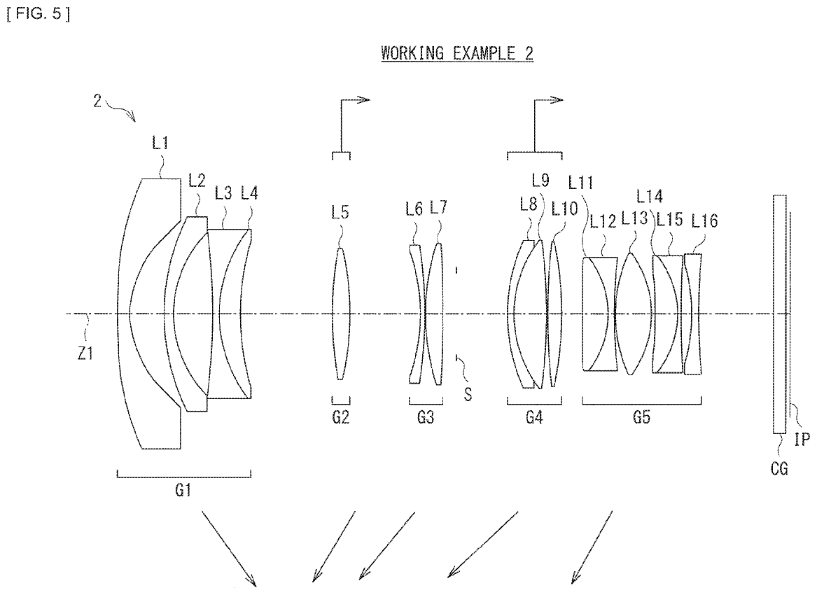

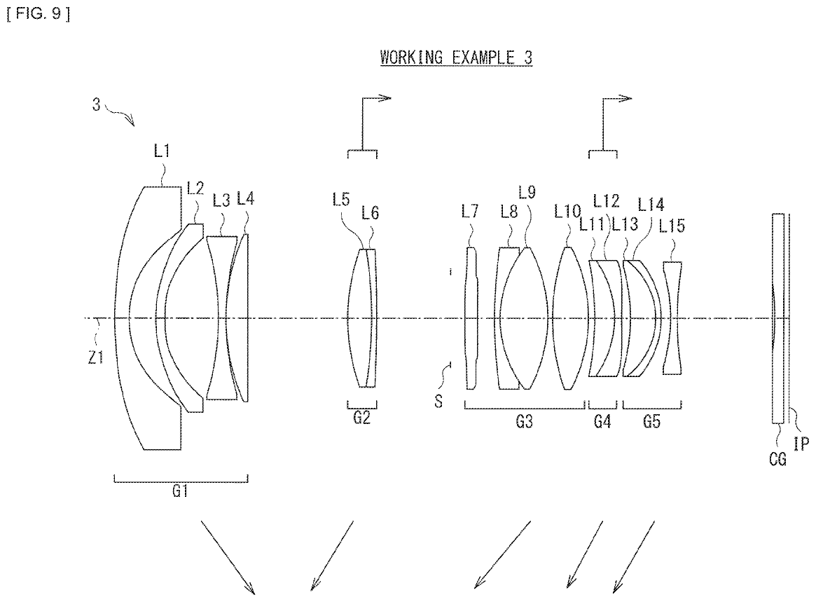

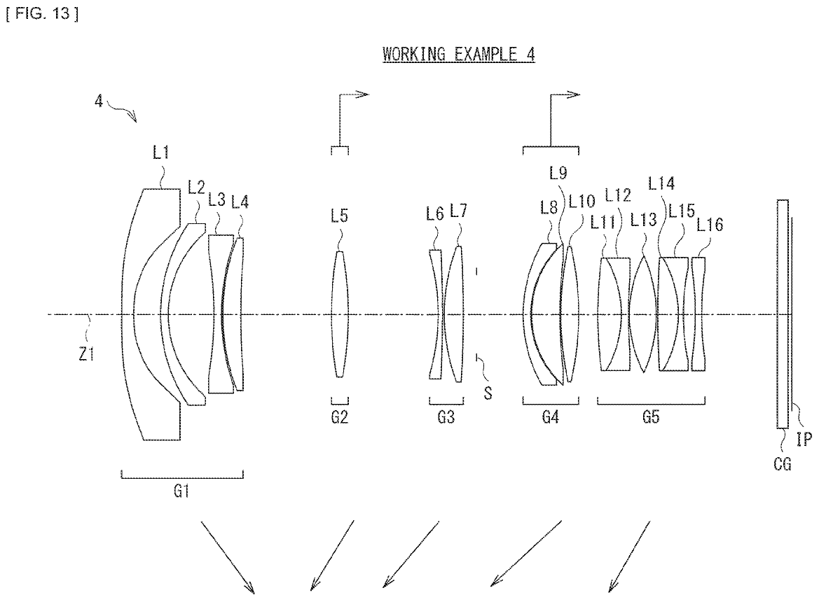

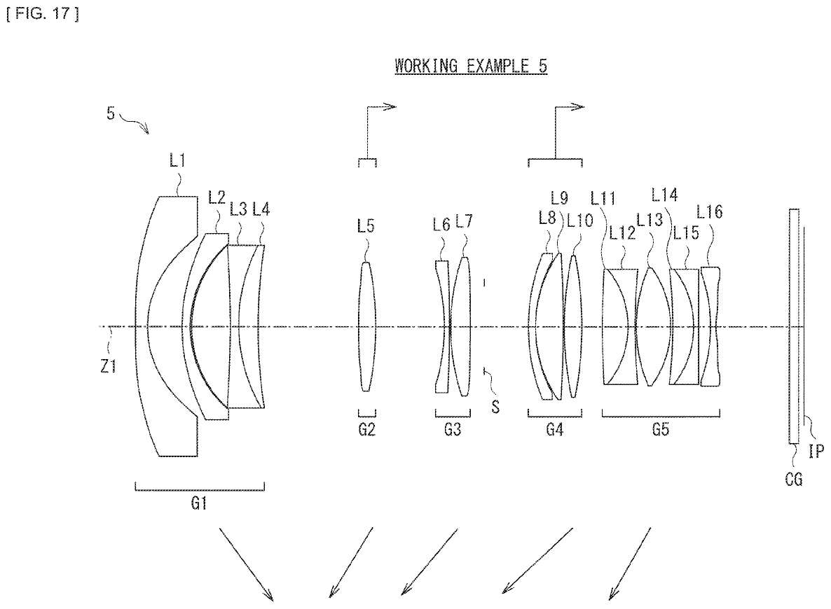

FIG. 1 illustrates a zoom lens 1 of a first configuration example according to one embodiment of the present disclosure. FIG. 5 illustrates a zoom lens 2 of a second configuration example. FIG. 9 illustrates a zoom lens 3 of a third configuration example. FIG. 13 illustrates a zoom lens 4 of a fourth configuration example. FIG. 17 illustrates a zoom lens 5 of a fifth configuration example. Numerical Working Examples in which specific numerical values are applied to those configuration examples are described later. In FIG. 1, etc., Z1 denotes an optical axis. Optical members such as a cover glass CG for protection of an imaging device or various kinds of optical filters may be provided between each of the zoom lenses 1 to 5 and an image plane IP.

In the following, a configuration of the zoom lens according to an embodiment of the present disclosure is described in association with the zoom lenses 1 to 5 of the respective configuration examples illustrated in FIG. 1, etc., where appropriate. However, a technique of the present disclosure is not limited to the illustrated configuration examples.

The zoom lens according to the present embodiment substantially includes five lens groups in which, in order from an object side toward an image plane side along the optical axis Z1, a first lens group G1 having negative refractive power, a second lens group G1 having positive refractive power, a third lens group G3 having positive refractive power, a fourth lens group G4 having positive or negative refractive power, and a fifth lens group G5 having negative refractive power are disposed.

Here, FIG. 1, FIG. 5, FIG. 9, FIG. 13, and FIG. 17 each illustrate disposition of each of lens groups at a wide angle end (a short focal distance end) upon infinity focusing. Further, FIG. 1, FIG. 5, FIG. 9, FIG. 13, and FIG. 17 each illustrate trajectories (arrows at the lower side of the figure) of traveling of the respective lens groups upon zooming from the wide angle end to the telephoto end.

In the zoom lens according to the present embodiment, intervals between the respective lens groups are changed on an optical axis upon zooming from the wide angle end to the telephoto end. The second lens group G2, the third lens group G3, the fourth lens group G4, and the fifth lens group G5 travel, upon zooming, to be positioned on the object side at the telephoto end as compared with the wide angle end. The first lens group G1 travels, upon zooming, to be positioned on the image plane side at the telephoto end as compared with the wide angle end.

Further, FIG. 1, FIG. 5, FIG. 9, FIG. 13, and FIG. 17 each illustrate traveling directions (arrows at the upper side of the figure) of the respective lens groups upon focusing when a subject distance is changed from infinity to proximity. The zoom lens according to the present embodiment performs focusing by causing the second lens group G2 and the fourth lens group G4 to travel toward the image plane side on the optical axis, upon changing of the subject distance from infinity to proximity.

Besides those described above, it is desirable that the zoom lens according to the present embodiment satisfy predetermined conditional expressions, etc., to be described later.

### 2. Workings and Effects

Next, description is given of workings and effects of the zoom lens according to the present embodiment. Description is also given together of a desirable configuration of the zoom lens according to the present embodiment.

It is to be noted that the effects described in the present specification are merely illustrative and non-limiting. Further, there may be any other effect as well.

According to the zoom lens of the present embodiment, optimization of a configuration of each of the lens groups is achieved in the zoom lens system having the five-group configuration as a whole, to perform focusing by causing the second lens group G2 and the fourth lens group G4 to travel upon changing of the subject distance from infinity to proximity, thus making it possible to achieve a favorable image-forming performance from infinity to proximity.

In particular, when intending to allow the maximum aperture F number to be 2.8 throughout all of focal distance regions to achieve a large diameter and intending to correct an optical performance throughout all regions from infinity to proximity, it is difficult to perform focusing using only a single lens. Performing focusing using three or more lens groups, however, makes it insufficient to have quick autofocusing. Accordingly, the zoom lens according to the present embodiment adopts a floating focus system that divides the focus lens group into the second lens groups G2 and the fourth lens group G2. This makes it possible to achieve both a larger diameter as well as the quick autofocusing.

It is desirable that the zoom lens according to the present embodiment satisfy the following conditional expression (1):

0.5<|2G/4G|<2.0 (1)
where
2G denotes a focal distance of the second lens group G2, and
4G denotes a focal distance of the fourth lens group G4.

The conditional expression (1) specifies a ratio of a focal distance of the fourth lens group G4 upon infinity focusing to a focal distance of the second lens group G2 upon the infinity focusing. Satisfying the conditional expression (1) makes it possible to have proper refractive power of the fourth lens group G4, thus making it possible to suppress variation in spherical aberration due to focusing. In addition, this also leads to proper extension amount of the focus lens group. Falling below the lower limit of the conditional expression (1) causes the refractive power of the fourth lens group G4 to be weak, thus making it difficult to correct the spherical aberration upon the focusing. In addition, the focusing extension amount of the fourth lens group G4 is increased, thus resulting in long optical total length, which is not preferable. Exceeding the upper limit of the conditional expression (1) causes the refractive power of the fourth lens group G4 to be strong, causing out of focus even in a case where the focus lens group slightly travels, thus making it difficult to control the focus lens group.

Incidentally, in order to achieve an effect of the above-described conditional expression (1) more favorably, it is more desirable that the numerical range of the conditional expression (1) be set as expressed by conditional expression (1)′ as follows.

0.6<|2G/4G|<1.7 (1)′

Further, it is desirable that the zoom lens according to the present embodiment satisfy the following conditional expression (2):

−0.5<t_2β/w_2β<0.6 (2)
where
t_2β denotes a lateral magnification of the second lens group G2 at a telephoto end, and
w_2β denotes a lateral magnification of the second lens group G2 at a wide angle end.

The conditional expression (2) specifies a ratio of the lateral magnification of the second lens group G2 at the wide angle end to the lateral magnification of the second lens group G2 at the telephoto end. Satisfying the conditional expression (2) makes it possible to have a proper variable magnification ratio in the second lens group G2 and to suppress occurrence of aberration in the second lens group G2. Falling below the lower limit of the conditional expression (2) makes it difficult to secure a variable magnification ratio to be borne by the second lens group G2, which variable magnification ratio is borne by the third lens group G3 or the fourth lens group G4. This makes it difficult to correct aberration, in particular, spherical aberration. Exceeding the upper limit of the conditional expression (2) causes the traveling amount of the second lens group G2 to be large, thus resulting in long optical total length.

Incidentally, in order to achieve an effect of the above-described conditional expression (2) more favorably, it is more desirable that the numerical range of the conditional expression (2) be set as expressed by conditional expression (2)′ as follows.

−0.3<t_2β/w_2β<0.5 (2)′

Further, it is desirable that the zoom lens according to the present embodiment satisfy the following conditional expression (3):

2.1<2G/(fw·ft)^{1/2}<3.0 (3)

where

2G denotes the focal distance of the second lens group G2,

fw denotes a focal distance of a total system at a wide angle end, and

ft denotes a focal distance of the total system at a telephoto end.

The conditional expression (3) specifies a ratio of the focal distance of the total system upon infinity focusing to the focal distance of the second lens group G2 upon the infinity focusing. Satisfying the conditional expression (3) makes it possible to have proper refractive power of the second lens group G2 and to suppress aberration variation in the spherical aberration or distortion aberration. Falling below the lower limit of the conditional expression (3) causes the refractive power of the second lens group G2 to be strong, thus making it difficult to secure backfocus necessary at a wide angle end. When intending to secure the backfocus, it is necessary to further increase refractive power of the first lens group G1, which results in occurrence of the distortion aberration, thus making it difficult to perform correction. Exceeding the upper limit of the conditional expression (3) causes the refractive power of the second lens group G2 to be weak, which results in larger aberration variation upon varied magnification, in particular, variation in the spherical aberration, thus making it difficult to perform correction.

Incidentally, in order to achieve an effect of the above-described conditional expression (3) more favorably, it is more desirable that the numerical range of the conditional expression (3) be set as expressed by conditional expression (3)′ as follows.

2.2<2G/(fw·ft)^{1/2}<2.9 (3)′

Further, it is desirable that the zoom lens according to the present embodiment satisfy the following conditional expression (4):

0.3<|4G/5G|<1.6 (4)

where

4G denotes the focal distance of the fourth lens group G4, and

5G denotes a focal distance of the fifth lens group G5.

The conditional expression (4) specifies a ratio of the focal distance of the fifth lens group G5 upon infinity focusing to the focal distance of the fourth lens group G4 upon the infinity focusing. Satisfying the conditional expression (4) makes it possible to have proper refractive power of the fifth lens group G5 and to suppress variation in the spherical aberration or coma aberration. Falling below the lower limit of the conditional expression (4) causes the refractive power of the fourth lens group G4 to be strong, which increases variation in the spherical aberration upon the focusing, thus making it difficult to perform correction. Exceeding the upper limit of the conditional expression (4) causes the refractive power of the fifth lens group G5 to be strong, thus making it difficult to correct the coma aberration.

Incidentally, in order to achieve an effect of the above-described conditional expression (4) more favorably, it is more desirable that the numerical range of the conditional expression (4) be set as expressed by conditional expression (4)′ as follows.

0.35<|4G/5G|<1.5 (4)′

Further, in the zoom lens according to the present embodiment, it is desirable that the first lens group G1 include one or more aspherical lenses.

In a wide angle zoom lens system, correcting the distortion aberration and field curvature in the first lens group G1 leads to reduction in load, on lens groups subsequent to the first lens group, in correcting the aberration. It is desirable that a positive lens be disposed in the first lens group G1 in order to correct the distortion aberration favorably. This, however, leads to larger size of the first lens group G1. Accordingly, disposing an aspherical lens makes it possible to achieve smaller size and to correct the distortion aberration and the field curvature favorably. Further, disposing two aspherical lenses in the first lens group G1 makes it possible to correct the distortion aberration and the field curvature more favorably.

Further, in the zoom lens according to the present embodiment, it is desirable that the fifth lens group G5 include one or more cemented lenses.

Configuring the fifth lens group G5 to include one or more cemented lenses makes it possible to correct chromatic aberration favorably.

### 3. Example of Application to Imaging Apparatus

Description is given next of examples of application, to an imaging apparatus, of the zoom lenses 1 to 5 according to the present embodiment.

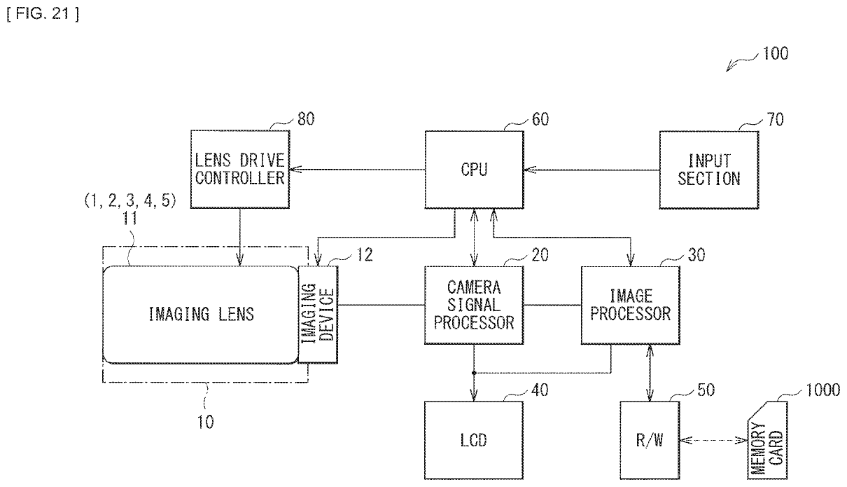

FIG. 21 illustrates a configuration example of an imaging apparatus 100 to which any of the zoom lenses 1 to 5 according to the present embodiment is applied. The imaging apparatus 100 is, for example, a digital still camera, and includes a camera block 10, a camera signal processor 20, an image processor 30, LCD (Liquid Crystal Display) 40, R/W (reader/writer) 50, CPU (Central Processing Unit) 60, an input section 70, and a lens drive controller 80.

The camera block 10 takes a role in an imaging function, and includes: an optical system including an imaging lens 11; and an imaging device 12 such as CCD (Charge Coupled Devices) or CMOS (Complementary Metal Oxide Semiconductor). The imaging device 12 converts an optical image formed by the imaging lens 11 into an electric signal, to thereby output an imaging signal (an image signal) that corresponds to the optical image. Any of the zoom lenses 1 to 5 of the respective configuration examples illustrated in FIG. 1, FIG. 5, FIG. 9, FIG. 13, and FIG. 17 is applicable as the imaging lens 11.

The camera signal processor 20 performs, on the image signal outputted from the imaging device 12, various kinds of signal processes including, for example, an analog-digital conversion, a noise removal, an image quality correction, or a conversion to luminance and color difference signals.

The image processor 30 performs processes of recording and reproduction of an image signal. The image processor 30 performs processes including, for example, compression coding and expansion decoding processes of an image signal based on a predetermined image data format, and a process of converting data specification such as resolution.

The LCD 40 has a function of displaying various pieces of data including, for example, a state of operation performed on the input section 70 by a user and a captured image. The R/W 50 performs writing of image data encoded by the image processor 30 into a memory card 1000, and reading of the image data recorded in the memory card 1000. The memory card 1000 is a semiconductor memory attachable to and detachable from a slot coupled to the R/W 50, for example.

The CPU 60 functions as a control processor that controls each of circuit blocks provided in the imaging apparatus 100. The CPU 60 controls each of the circuit blocks on the basis of, for example, an instruction input signal from the input section 70. The input section 70 includes, for example, various switches on which necessary operations are performed by the user. For example, the input section 70 includes a shutter release button used to perform a shutter operation, a selection switch used to select an operation mode, etc. The input section 70 outputs, to the CPU 60, the instruction input signal that corresponds to the operation performed by the user. The lens drive controller 80 controls driving of lenses disposed in the camera block 10. The lens drive controller 80 controls, for example, unillustrated motors that drive respective lenses of the imaging lens 11 on the basis of a control signal from the CPU 60.

In the following, description is given of operations in the imaging apparatus 100.

In a standby state upon image capturing, an image signal captured in the camera block 10 is outputted to the LCD 40 through the camera signal processor 20 and is thus displayed as a camera-through image, under control of the CPU 60. Further, for example, when the instruction input signal, for zooming or focusing, from the input section 70 is inputted, the CPU 60 outputs the control signal to the lens drive controller 80. This causes a predetermined lens of the imaging lens 11 to travel on the basis of control performed by the lens drive controller 80.

When an unillustrated shutter of the camera block 10 is operated in response to the instruction input signal from the input section 70, the captured image signal is outputted from the camera signal processor 20 to the image processor 30. The captured image signal outputted to the image processor 30 is subjected to the compression coding process and is thus converted into digital data in a predetermined data format. The converted data is outputted to the R/W 50 to be written into the memory card 1000.

It is to be noted that the focusing is performed in a case where the shutter release button of the input section 70 is pressed halfway, or in a case where the shutter release button is pressed fully for recording (image capturing), for example. The focusing is performed by causing a predetermined lens of the imaging lens 11 to travel by the lens drive controller 80 on the basis of the control signal from the CPU 60.

In a case where the image data recorded in the memory card 1000 is to be reproduced, predetermined image data is read from the memory card 1000 by the R/W 50 in accordance with the operation performed on the input section 70. The predetermined image data read from the memory card 1000 is subjected to the expansion decoding process by the image processor 30. Thereafter, a reproduction image signal is outputted to the LCD 40 and a reproduced image is thus displayed.

It is to be noted that, although the above-described embodiment illustrates an example in which the imaging apparatus is applied to the digital still camera, etc., a range of application of the imaging apparatus is not limited to the digital still camera. The imaging apparatus is applicable to other various imaging apparatuses. For example, the imaging apparatus is applicable to a digital single-lens reflex camera, a digital non-reflex camera, a digital video camera, a surveillance camera, etc. Further, the imaging apparatus is applicable widely to, for example, a camera section of a digital input-output device such as a mobile phone mounted with a camera or an information terminal mounted with a camera. In addition, the imaging apparatus is applicable to an interchangeable-lens camera as well.

### Working Examples

### 4. Numerical Working Examples of Lenses

Next, description is given of specific Numerical Working Examples of the zoom lens 1 to 5 according to the present embodiment. Here, the description is given of Numerical Working Examples in which specific numerical values are applied to the zoom lenses 1 to 5 of the respective configuration examples illustrated in FIG. 1, FIG. 5, FIG. 9, FIG. 13, and FIG. 17.

It is to be noted that meanings, etc. of respective symbols indicated in the following tables and descriptions are as follows. “Surface No.” denotes number of i-th surface counting from the object side to the image plane side. “Ri” denotes a value (mm) of a paraxial radius of curvature of the i-th surface. “Di” denotes a value (mm) of an on-axis surface interval (a thickness of lens center or an air space) between the i-th surface and (i+1)-th surface. “Ndi” denotes a value of refractive index in a d-line (wavelength of 587.6 nm) of a lens, etc. that starts from the i-th surface. “vdi” denotes a value of Abbe number in the d-line of the lens, etc. that starts from the i-th surface. A portion where the value of “Ri” is “INF” indicates a flat surface or an aperture stop surface (an aperture stop S). In the “Surface No.”, a surface denoted as “ASP” is an aspherical surface. A surface denoted as “IRIS” is the aperture stop S. “f” denotes a focal distance of the total system upon the infinity focusing, “Fno” denotes an F number (maximum aperture F value), and “w” denotes a half angle of view. “BF” denotes backfocus.

Each of Numerical Working Examples includes a lens surface formed into an aspherical surface. A shape of the aspherical surface is defined by the following aspherical surface expression. In the following aspherical surface expression, a distance from an apex of a lens surface in an optical axis direction is denoted as “x”, a height in a direction orthogonal to the optical axis direction is denoted as “y”, and paraxial curvature at a lens apex (inverse of the paraxial radius of curvature) is denoted as “c”. “K” denotes a conic constant (conic constant), and “Ai” denotes an i-th order aspherical coefficient. Incidentally, in each of Tables that indicate the following aspherical coefficients, “E-n” denotes an exponential expression using 10 as a base, i.e., “minus n-th power of 10”. For example, “0.12345E-05” denotes “0.12345×(minus fifth power of 10)”.

x=y²c²/[1+{1−(1+K)y²c²}^{1/2}]+ΣAi·yⁱ (Aspherical Surface Expression)

### Configuration Common to Each Numerical Working Example

The zoom lenses 1 to 5 to which the following respective Numerical Working Examples 1 to 5 are applied each have a configuration that satisfies the above-described <1. Basic Configuration of Lenses>. That is, the zoom lenses 1 to 5 each have the configuration in which the first lens group G1 having the negative refractive power, the second lens group G1 having the positive refractive power, the third lens group G3 having the positive refractive power, the fourth lens group G4 having the positive or negative refractive power, and the fifth lens group G5 having the negative refractive power are disposed in order from the object side toward the image plane side.

In each of the zoom lenses 1 to 5, intervals between the respective lens groups are changed on the optical axis upon zooming from the wide angle end to the telephoto end. The second lens group G2, the third lens group G3, the fourth lens group G4, and the fifth lens group G5 travel, upon zooming, to be positioned on the object side at the telephoto end as compared with the wide angle end. The first lens group G1 travels, upon zooming, to be positioned on the image plane side at the telephoto end as compared with the wide angle end.

The zoom lenses 1 to 5 each perform focusing by causing the second lens group G2 and the fourth lens group G4 to travel toward the image plane side on the optical axis, upon changing of the subject distance from infinity to proximity.

### Numerical Working Example 1

In the zoom lens 1 illustrated in FIG. 1, the first lens group G1 includes a first lens L1, a second lens L2, and a cemented lens having negative refractive power in which a third lens L3 and a fourth lens L4 are cemented. The first lens L1 has a convex shape toward the object side and has negative refractive power. The second lens L2 has a convex shape toward the object side and has negative refractive power. The third lens L3 has a concave shape toward both sides and has negative refractive power. The fourth lens L4 is disposed on the image plane side of the third lens L3, has a convex shape toward the object side, and has positive refractive power.

The second lens group G2 includes a cemented lens having positive refractive power in which a fifth lens L5 and a sixth lens L6 are cemented. The fifth lens L5 has a convex shape toward the object side and has negative refractive power. The sixth lens L6 is disposed on the image plane side of the fifth lens L5, has a convex shape toward both the sides, and has positive refractive power.

The third lens group G3 includes a seventh lens L7 having a convex shape toward the object side and having positive refractive power.

The fourth lens group G4 includes a cemented lens having positive refractive power in which an eighth lens L8 and a ninth lens L9 are cemented. The eighth lens L8 has a convex shape toward the object side and has negative refractive power. The ninth lens L9 is disposed on the image plane side of the eighth lens L8, has a convex shape toward both the sides, and has positive refractive power.

The fifth lens group G5 includes a cemented lens having negative refractive power in which a tenth lens L10 and an eleventh lens L11 are cemented, a twelfth lens L12, a cemented lens having positive refractive power in which a thirteenth lens L13 and a fourteenth lens L14 are cemented, and a fifteenth lens L15. The tenth lens L10 has a convex shape toward the image plane side and has positive refractive power. The eleventh lens L11 is disposed on the image plane side of the tenth lens L10, has a concave shape toward the object side, and has negative refractive power. The twelfth lens L12 has a convex shape toward both the sides and has positive refractive power. The thirteenth lens L13 has a concave shape toward both the sides and has negative refractive power. The fourteenth lens L14 is disposed on the image plane side of the thirteenth lens L13, has a convex shape toward both the sides, and has positive refractive power. The fifteenth lens L15 has a concave shape toward both the sides and has negative refractive power.

The aperture stop S is disposed between the third lens group G3 and the fourth lens group G4. The image plane IP is disposed on the image plane side of the fifth lens group G5. The cover glass CG is disposed between the fifth lens group G5 and the image plane IP.

[Table 1] lists basic lens data of Numerical Working Example 1 in which specific numerical values are applied to the zoom lens 1. In [Table 1], intervals that are variable upon zooming are referred to as D(1), D(2), D(3), D(4), and D(5). Values of these variable intervals are listed in [Table 2].

In the zoom lens 1, an aspherical surface is formed on each of a surface (a first surface) on the object side and a surface (a second surface) on the image plane side of the first lens L1, a surface (a fourth surface) on the image plane side of the second lens L2, and a surface (an eleventh surface) on the object side and a surface (a twelfth surface) on the image plane side of the seventh lens L7. Further, an aspherical surface is formed on each of a surface (a nineteenth surface) on the image plane side of the eleventh lens L11 and a surface (a twenty-fifth surface) on the object side and a surface (a twenty-sixth surface) on the image plane side of the fifteenth lens L15. Values of fourth, sixth, eighth, tenth, and twelfth degree aspherical coefficients A4, A6, A8, A10, and A12 of each of the aspherical surfaces in Numerical Working Example 1 are listed, together with a conic coefficient K, in [Table 3].

Further, [Table 4] lists values of the focal distance f of the total system, the F number (Fno), the backfocus BF, and the half angle of view w upon the infinity focusing in the zoom lens 1.

TABLE 1
Working Example 1

| Surface No. | Ri | Di | Ndi | νdi |
|---|---|---|---|---|
| 1(ASP) | 650.000 | 2.800 | 1.768015 | 49.2 |
| 2(ASP) | 22.500 | 6.316 | | |
| 3 | 35.231 | 1.860 | 1.834850 | 42.7 |
| 4(ASP) | 27.294 | 9.584 | | |
| 5 | −105.116 | 1.800 | 1.496997 | 81.6 |
| 6 | 29.817 | 3.637 | 1.921189 | 24.0 |
| 7 | 56.314 | D(1) | | |
| 8 | 49.501 | 1.500 | 1.834001 | 37.3 |
| 9 | 25.625 | 7.212 | 1.658436 | 50.9 |
| 10 | −78.218 | D(2) | | |
| 11(ASP) | 48.543 | 4.040 | 1.487489 | 70.4 |
| 12(ASP) | 73.565 | 2.184 | | |
| 13(IRIS) | INF | D(3) | | |
| 14 | 31.662 | 1.500 | 1.834001 | 37.3 |
| 15 | 22.000 | 9.434 | 1.496997 | 81.6 |
| 16 | −44.361 | D(4) | | |
| 17 | −110.638 | 3.737 | 1.496997 | 81.6 |
| 18 | −22.500 | 1.500 | 1.851348 | 40.1 |
| 19(ASP) | −234.334 | 0.500 | | |
| 20 | 39.683 | 8.317 | 1.496997 | 81.6 |
| 21 | −21.963 | 0.500 | | |
| 22 | −43.721 | 1.500 | 1.846663 | 23.8 |
| 23 | 221.809 | 7.856 | 1.922860 | 20.9 |
| 24 | −30.195 | 0.513 | | |
| 25(ASP) | −32.045 | 1.500 | 1.851348 | 40.1 |
| 26(ASP) | 65.000 | D(5) | | |
| 27 | INF | 2.500 | 1.516798 | 64.2 |
| 28 | INF | BF | | |

TABLE 2
Working Example 1

| Variable | Wide Angle | Intermediate | |
|---|---|---|---|
| Interval | End | Focal Distance | Telephoto End |
| D(1) | 23.53 | 12.50 | 4.48 |
| D(2) | 6.58 | 7.12 | 5.89 |
| D(3) | 11.54 | 7.30 | 2.33 |
| D(4) | 2.62 | 5.21 | 8.41 |
| D(5) | 16.92 | 24.81 | 37.18 |

TABLE 3
Working Example 1

| Surface No. | K | A4 | A6 | A8 | A10 | A12 |
|---|---|---|---|---|---|---|
| 1 | −0.900 | 2.63E−07 | −5.71E−08 | 7.90E−11 | −6.22E−14 | 2.13E−17 |
| 2 | −0.072 | 8.20E−06 | 3.81E−08 | −2.67E−10 | 2.18E−13 | 0.00E+00 |
| 4 | −0.271 | 2.00E−05 | −3.60E−08 | 2.16E−10 | 6.99E−14 | 0.00E+00 |
| 11 | 0.000 | −2.91E−05 | −2.22E−08 | −3.30E−11 | 0.00E+00 | 0.00E+00 |
| 12 | 0.000 | −3.45E−05 | −1.14E−08 | −6.13E−12 | 0.00E+00 | 0.00E+00 |
| 19 | 0.000 | 1.74E−05 | 4.01E−08 | 6.76E−11 | 0.00E+00 | 0.00E+00 |
| 25 | 0.000 | −6.22E−06 | 3.38E−08 | −6.32E−11 | 0.00E+00 | 0.00E+00 |
| 26 | 0.000 | 7.34E−06 | 3.43E−08 | −7.15E−11 | 0.00E+00 | 0.00E+00 |

TABLE 4
Working Example 1

| | Wide Angle | Intermediate | Telephoto |
|---|---|---|---|
| | End | Focal Distance | End |
| F | 16.5 | 22.9 | 33.9499 |
| Fno | 2.88 | 2.88 | 2.88 |
| BF | 1.00 | 1.00 | 1.00 |
| Ω | 54.08 | 43.17 | 31.74 |

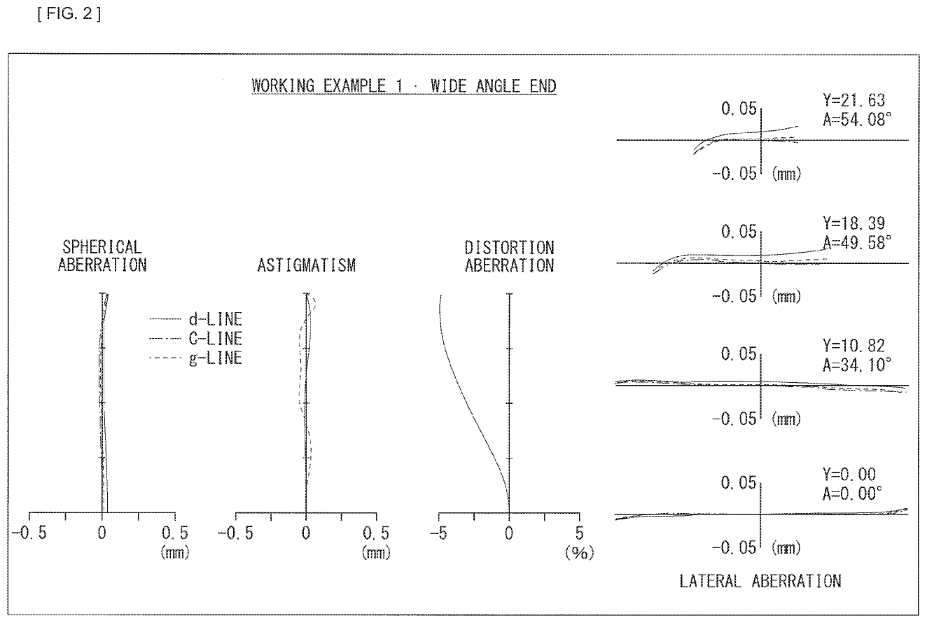

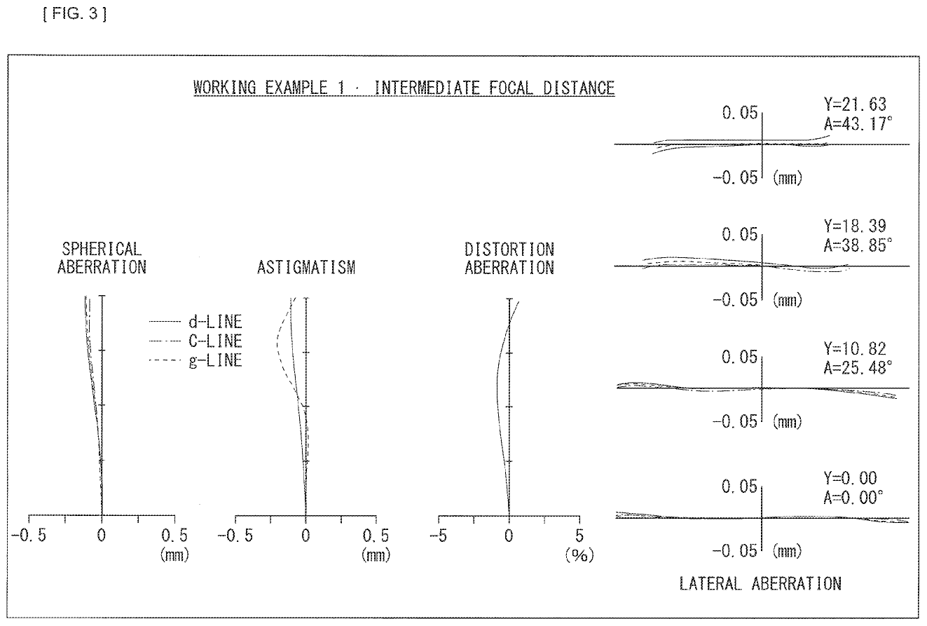

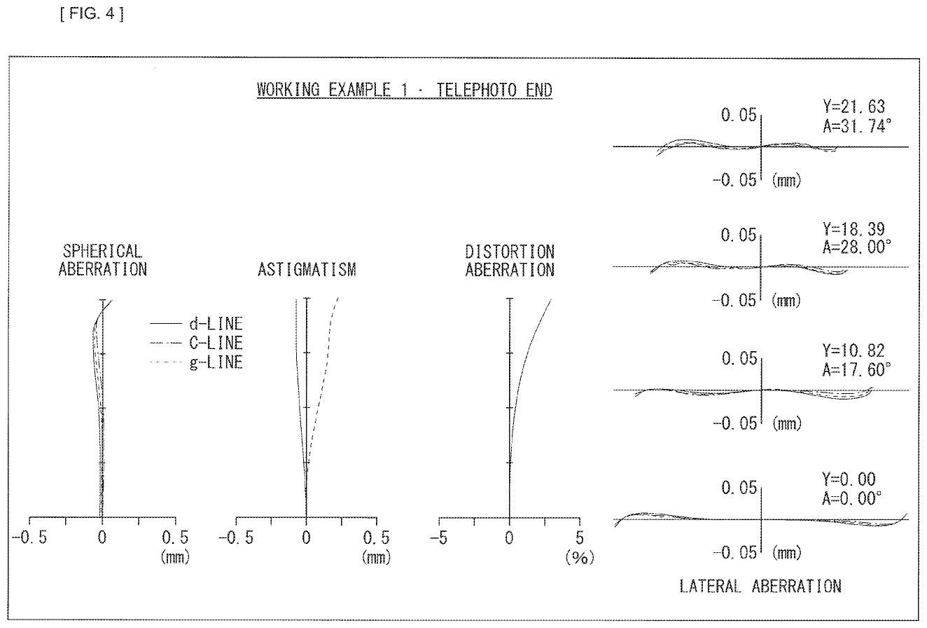

FIG. 2 illustrates various aberrations at a wide angle end in Numerical Working Example 1. FIG. 3 illustrates various aberrations at an intermediate focal distance in Numerical Working Example 1. FIG. 4 illustrates various aberrations at a telephoto end in Numerical Working Example 1. FIG. 2 to FIG. 4 each illustrate, as various aberrations, spherical aberration, astigmatism (field curvature), lateral aberration (coma aberration), and distortion aberration. In the astigmatism, a solid line indicates a value in a sagittal image plane, and a broken line indicates a value in a meridional image plane. Each of the aberration diagrams indicates values with the d-line as a reference wavelength. The spherical aberration diagram and the lateral aberration diagram also indicate values of a C-line (the wavelength of 656.28 nm) and a g-line (the wavelength of 435.84 nm). In the lateral aberration diagram, Y denotes an image height and A denotes an image angle. These apply similarly to aberration diagrams in subsequent other Numeral Working Examples.

As can be appreciated from each of the aberration diagrams, each of the aberrations are favorably corrected in a balanced fashion at the wide angle end, at the intermediate focal distance, and at the telephoto end, in Numerical Working Example 1. Hence, it is clear that the zoom lens 1 has a superior image-forming performance.

### Numerical Working Example 2

In the zoom lens 2 illustrated in FIG. 5, the first lens group G1 includes the first lens L1, the second lens L2, and a cemented lens having negative refractive power in which the third lens L3 and the fourth lens L4 are cemented. The first lens L1 has a convex shape toward the object side and has negative refractive power. The second lens L2 has a convex shape toward the object side and has negative refractive power. The third lens L3 has a concave shape toward both the sides and has negative refractive power. The fourth lens L4 is disposed on the image plane side of the third lens L3, has a convex shape toward the object side, and has positive refractive power.

The second lens group G2 includes the fifth lens L5 having a convex shape toward both the sides and having positive refractive power.

The third lens group G3 includes the sixth lens L6 having a convex shape toward the image plane side and having negative refractive power and the seventh lens L7 having a convex shape toward both the sides and having positive refractive power.

The fourth lens group G4 includes a cemented lens having positive refractive power in which the eighth lens L8 and the ninth lens L9 are cemented, and the tenth lens L10. The eighth lens L8 has a convex shape toward the object side and has negative refractive power. The ninth lens L9 is disposed on the image plane side of the eighth lens L8, has a convex shape toward both the sides, and has positive refractive power. The tenth lens L10 has a convex shape toward both the sides and has positive refractive power.

The fifth lens group G5 includes a cemented lens having negative refractive power in which the eleventh lens L11 and the twelfth lens L12 are cemented, the thirteenth lens L13, a cemented lens having negative refractive power in which the fourteenth lens L14 and the fifteenth lens L15 are cemented, and a sixteenth lens L16. The eleventh lens L11 has a convex shape toward both the sides and has positive refractive power. The twelfth lens L12 is disposed on the image plane side of the eleventh lens L11, has a concave shape toward both the sides, and has negative refractive power. The thirteenth lens L13 has a convex shape toward both the sides and has positive refractive power. The fourteenth lens L14 has a convex shape toward the image plane side and has positive refractive power. The fifteenth lens L15 is disposed on the image plane side of the fourteenth lens L14, has a concave shape toward both the sides, and has negative refractive power. The sixteenth lens L16 has a concave shape toward both the sides and has negative refractive power.

The aperture stop S is disposed between the third lens group G3 and the fourth lens group G4. The image plane IP is disposed on the image plane side of the fifth lens group G5. The cover glass CG is disposed between the fifth lens group G5 and the image plane IP.

[Table 5] lists basic lens data of Numerical Working Example 2 in which specific numerical values are applied to the zoom lens 2. In [Table 5], intervals that are variable upon zooming are referred to as D(1), D(2), D(3), D(4), and D(5). Values of these variable intervals are listed in [Table 6].

In the zoom lens 2, an aspherical surface is formed on each of a surface (a first surface) on the object side and a surface (a second surface) on the image plane side of the first lens L1, a surface (a fourth surface) on the image plane side of the second lens L2, and a surface (a twelfth surface) on the object side and a surface (a thirteenth surface) on the image plane side of the seventh lens L7. Further, an aspherical surface is formed on each of a surface (a twenty-second surface) on the image plane side of the twelfth lens L12 and a surface (a twenty-eighth surface) on the object side and a surface (a twenty-ninth surface) on the image plane side of the sixteenth lens L16. Values of fourth, sixth, eighth, tenth, and twelfth degree aspherical coefficients A4, A6, A8, A10, and A12 of each of the aspherical surfaces in Numerical Working Example 2 are listed, together with the conic coefficient K, in [Table 7].

Further, [Table 8] lists values of the focal distance f of the total system, the F number (Fno), the backfocus BF, and the half angle of view w upon the infinity focusing in the zoom lens 2.

TABLE 5
Working Example 2

| Surface No. | Ri | Di | Ndi | νdi |
|---|---|---|---|---|
| 1(ASP) | 400.000 | 2.800 | 1.768015 | 49.2 |
| 2(ASP) | 23.779 | 7.500 | | |
| 3 | 48.030 | 1.860 | 1.834805 | 42.7 |
| 4(ASP) | 30.865 | 8.500 | | |
| 5 | −218.488 | 1.800 | 1.589129 | 61.3 |
| 6 | 30.419 | 4.471 | 1.921189 | 24.0 |
| 7 | 62.375 | D(1) | | |
| 8 | 103.062 | 3.850 | 1.658436 | 50.9 |
| 9 | −67.210 | D(2) | | |
| 10 | −48.000 | 1.100 | 1.834000 | 37.3 |
| 11 | −123.300 | 0.200 | | |
| 12(ASP) | 45.799 | 3.725 | 1.583130 | 59.5 |
| 13(ASP) | −733.653 | 3.100 | | |
| 14(IRIS) | INF | D(3) | | |
| 15 | 38.368 | 1.600 | 1.775000 | 27.5 |
| 16 | 27.685 | 7.000 | 1.487490 | 70.4 |
| 17 | −197.098 | 0.200 | | |
| 18 | 132.171 | 3.402 | 1.592824 | 68.6 |
| 19 | −83.216 | D(4) | | |
| 20 | 250.643 | 5.674 | 1.496997 | 81.6 |
| 21 | −20.352 | 1.851 | 1.851348 | 40.1 |
| 22(ASP) | 171.241 | 0.200 | | |
| 23 | 34.725 | 7.816 | 1.496997 | 81.6 |
| 24 | −22.581 | 0.700 | | |
| 25 | −151.944 | 4.902 | 1.922860 | 20.9 |
| 26 | −20.796 | 1.000 | 1.903658 | 31.3 |
| 27 | 1888.584 | 2.185 | | |
| 28(ASP) | −46.916 | 1.500 | 1.851348 | 40.1 |
| 29(ASP) | 187.660 | D(5) | | |
| 27 | INF | 2.500 | 1.516798 | 64.2 |
| 28 | INF | BF | | |

TABLE 6
Working Example 2

| Variable | Wide Angle | Intermediate | |
|---|---|---|---|
| Interval | End | Focal Distance | Telephoto End |
| D(1) | 20.39 | 10.11 | 3.70 |
| D(2) | 15.20 | 13.46 | 8.19 |
| D(3) | 10.98 | 6.51 | 2.50 |
| D(4) | 4.35 | 6.69 | 9.68 |
| D(5) | 16.51 | 24.35 | 35.67 |

TABLE 7
Working Example 2

| Surface No. | K | A4 | A6 | A8 | A10 | A12 |
|---|---|---|---|---|---|---|
| 1 | 0.000 | 1.64E−05 | −2.91E−08 | 3.32E−11 | −2.24E−14 | 6.78E−18 |
| 2 | −0.025 | 4.06E−06 | 1.36E−08 | −6.90E−11 | −2.81E−14 | 0.00E+00 |
| 4 | 0.000 | 1.12E−05 | −2.35E−08 | 8.41E−11 | 1.54E−14 | 0.00E+00 |
| 12 | 0.000 | −3.85E−06 | −1.05E−08 | 0.00E+00 | 0.00E+00 | 0.00E+00 |
| 13 | 0.000 | −1.95E−06 | −7.93E−09 | −1.24E−12 | 0.00E+00 | 0.00E+00 |
| 22 | 0.000 | 9.52E−06 | 2.21E−08 | 7.02E−11 | 0.00E+00 | 0.00E+00 |
| 28 | 0.000 | −5.87E−06 | 5.29E−09 | 4.16E−11 | 0.00E+00 | 0.00E+00 |
| 29 | 0.000 | 1.72E−05 | 1.93E−08 | −4.62E−12 | 0.00E+00 | 0.00E+00 |

TABLE 8
Working Example 2

| | Wide Angle | Intermediate | Telephoto |
|---|---|---|---|
| | End | Focal Distance | End |
| f | 16.5 | 22.9 | 33.95 |
| Fno | 2.88 | 2.88 | 2.88 |
| BF | 1.00 | 1.00 | 1.00 |
| ω | 54.07 | 43.28 | 31.71 |

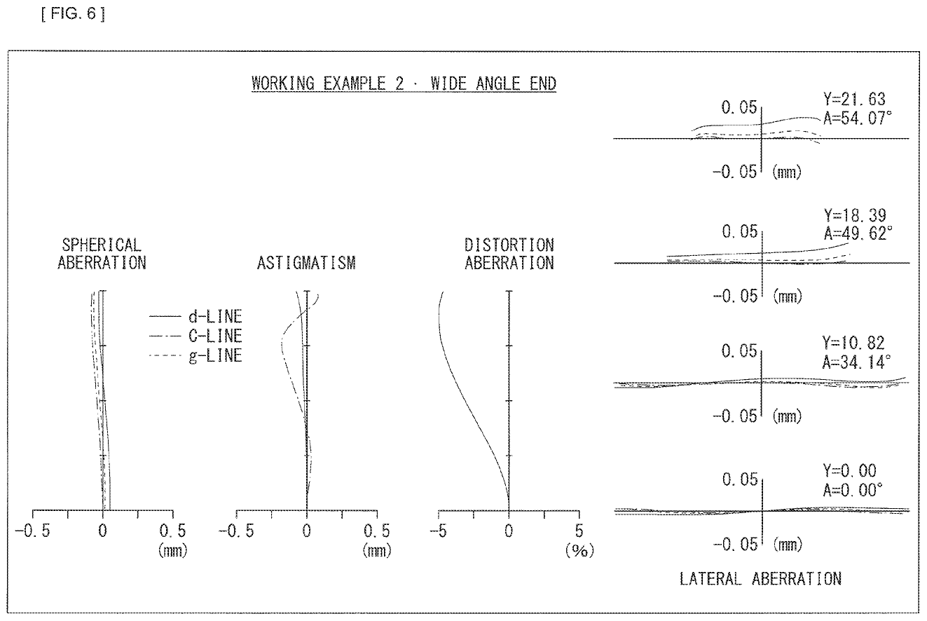

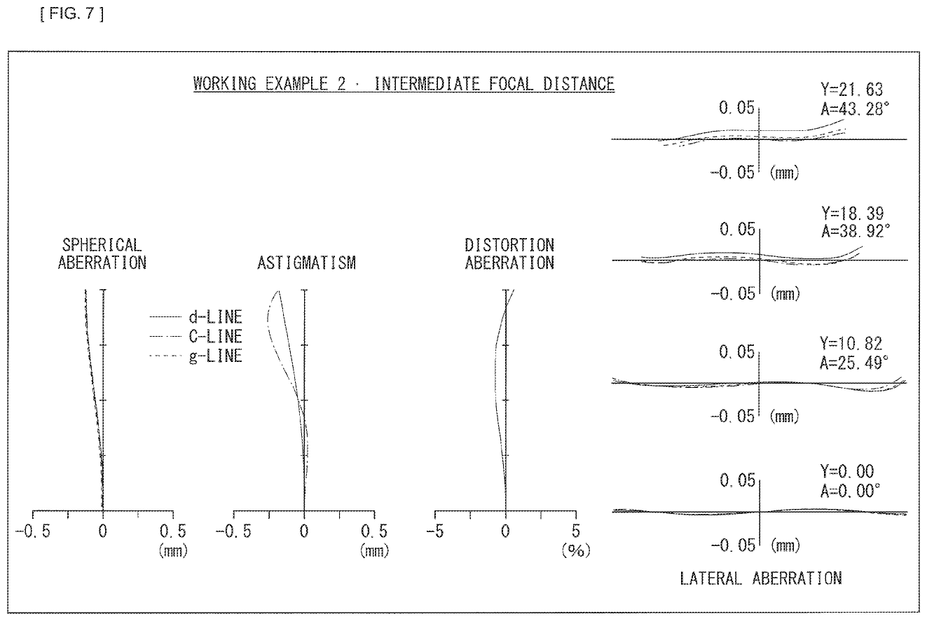

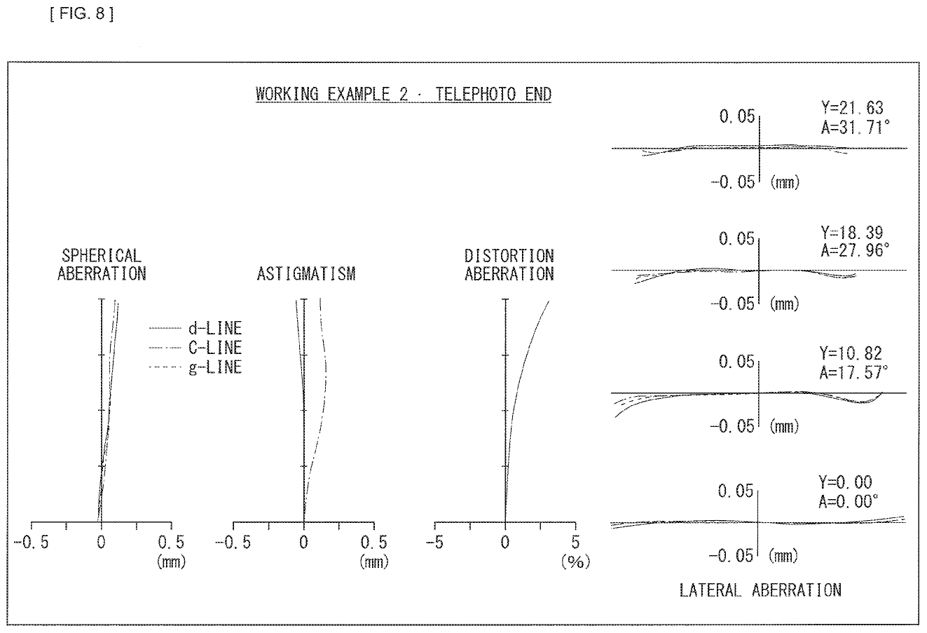

FIG. 6 illustrates various aberrations at a wide angle end in Numerical Working Example 2. FIG. 7 illustrates various aberrations at an intermediate focal distance in Numerical Working Example 2. FIG. 8 illustrates various aberrations at a telephoto end in Numerical Working Example 2.

As can be appreciated from each of the aberration diagrams, each of the aberrations are favorably corrected in a balanced fashion at the wide angle end, at the intermediate focal distance, and at the telephoto end, in Numerical Working Example 2. Hence, it is clear that the zoom lens 2 has a superior image-forming performance.

### Numerical Working Example 3

In the zoom lens 3 illustrated in FIG. 9, the first lens group G1 includes the first lens L1 having a convex shape toward the object side and having negative refractive power, the second lens L2 having a convex shape toward the object side and having negative refractive power, the third lens L3 having a concave shape toward both the sides and having negative refractive power, and the fourth lens L4 having a convex shape toward the object side and having positive refractive power.

The second lens group G2 includes a cemented lens having positive refractive power in which the fifth lens L5 and the sixth lens L6 are cemented.

The third lens group G3 includes the seventh lens L7, a cemented lens having positive refractive power in which the eighth lens L8 and the ninth lens L9 are cemented, and the tenth lens L10. The seventh lens L7 has a convex shape toward both the sides and has positive refractive power. The eighth lens L8 has a convex shape toward the object side and has negative refractive power. The ninth lens L9 is disposed on the image plane side of the eighth lens L8, has a convex shape toward both the sides, and has positive refractive power. The tenth lens L10 has a convex shape toward both the sides and has positive refractive power.

The fourth lens group G4 includes a cemented lens having negative refractive power in which the eleventh lens L11 and the twelfth lens L12 are cemented. The eleventh lens L11 has a convex shape toward the object side and has positive refractive power. The twelfth lens L12 is disposed on the image plane side of the eleventh lens L11, has a convex shape toward the image plane side, and has negative refractive power.

The fifth lens group G5 includes a cemented lens having positive refractive power in which the thirteenth lens L13 and the fourteenth lens L14 are cemented, and the fifteenth lens L15. The thirteenth lens L13 has a convex shape toward the image plane side and has positive refractive power. The fourteenth lens L14 is disposed on the image plane side of the thirteenth lens L13, has a convex shape toward the image plane side, and has negative refractive power. The fifteenth lens L15 has a concave shape toward both the sides and has negative refractive power.

The aperture stop S is disposed between the second lens group G2 and the third lens group G3. The image plane IP is disposed on the image plane side of the fifth lens group G5. The cover glass CG is disposed between the fifth lens group G5 and the image plane IP.

[Table 9] lists basic lens data of Numerical Working Example 3 in which specific numerical values are applied to the zoom lens 3. In [Table 9], intervals that are variable upon zooming are referred to as D(1), D(2), D(3), D(4), and D(5). Values of these variable intervals are listed in [Table 10].

In the zoom lens 3, an aspherical surface is formed on each of a surface (a first surface) on the object side and a surface (a second surface) on the image plane side of the first lens L1, a surface (a fourth surface) on the image plane side of the second lens L2, a surface (a ninth surface) on the object side of the fifth lens L5, and a surface (a thirteenth surface) on the object side of the seventh lens L7. Further, an aspherical surface is formed on each of a surface (a twenty-second surface) on the image plane side of the twelfth lens L12 and a surface (a twenty-seventh surface) on the image plane side of the fifteenth lens L15. Values of fourth, sixth, eighth, tenth, and twelfth degree aspherical coefficients A4, A6, A8, A10, and A12 of each of the aspherical surfaces in Numerical Working Example 3 are listed, together with the conic coefficient K, in [Table 11].

Further, [Table 12] lists values of the focal distance f of the total system, the F number (Fno), the backfocus BF, and the half angle of view w upon the infinity focusing in the zoom lens 3.

TABLE 9
Working Example 3

| Surface No. | Ri | Di | Ndi | νdi |
|---|---|---|---|---|
| 1(ASP) | 213.857 | 2.800 | 1.768015 | 49.2 |
| 2(ASP) | 21.251 | 5.780 | | |
| 3 | 32.998 | 1.800 | 1.834805 | 42.7 |
| 4(ASP) | 24.000 | 11.568 | | |
| 5 | −59.875 | 1.500 | 1.592824 | 68.6 |
| 6 | 59.661 | 0.200 | | |
| 7 | 45.573 | 4.428 | 1.755200 | 27.5 |
| 8 | 1065.021 | D(1) | | |
| 9(ASP) | 47.167 | 4.905 | 1.594230 | 59.1 |
| 10 | −120.000 | 1.300 | 1.772500 | 49.6 |
| 11 | −206.493 | D(2) | | |
| 12(IRIS) | INF | 3.000 | | |
| 13(ASP) | 113.599 | 2.806 | 1.834410 | 37.3 |
| 14 | −173.123 | 3.600 | | |
| 15 | 110.802 | 1.300 | 1.984413 | 30.1 |
| 16 | 26.613 | 10.000 | 1.493724 | 74.2 |
| 17 | −34.044 | 1.210 | | |
| 18 | 49.204 | 7.494 | 1.512500 | 73.0 |
| 19 | −34.148 | D(3) | | |
| 20 | −63.417 | 4.180 | 1.792283 | 25.4 |
| 21 | −20.348 | 1.500 | 1.882020 | 37.2 |
| 22(ASP) | −167.892 | D(4) | | |
| 23 | −49.477 | 5.457 | 1.497000 | 81.6 |
| 24 | −15.493 | 1.200 | 1.902011 | 34.1 |
| 25 | −20.381 | 2.063 | | |
| 26 | −37.392 | 1.300 | 1.882020 | 37.2 |
| 27(ASP) | 466.837 | D(5) | | |
| 28 | INF | 2.500 | 1.516798 | 64.2 |
| 29 | INF | BF | | |

TABLE 10
Working Example 3

| Variable | Wide Angle | Intermediate | |
|---|---|---|---|
| Interval | End | Focal Distance | Telephoto End |
| D(1) | 21.68 | 9.65 | 2.00 |
| D(2) | 15.64 | 9.80 | 3.44 |
| D(3) | 1.49 | 1.60 | 2.61 |
| D(4) | 1.75 | 2.85 | 3.12 |
| D(5) | 20.24 | 29.12 | 39.72 |

TABLE 11
Working Example 3

| Surface No. | K | A4 | A6 | A8 | A10 | A12 |
|---|---|---|---|---|---|---|
| 1 | 0.000 | 1.52E−05 | −1.98E−08 | 1.41E−11 | −4.28E−15 | 0.00E+00 |
| 2 | −0.134 | 1.34E−06 | 1.81E−08 | 2.45E−11 | −2.26E−13 | 0.00E+00 |
| 4 | 0.000 | 1.10E−05 | −7.87E−09 | −7.76E−11 | 3.86E−13 | 0.00E+00 |
| 9 | 0.000 | −3.44E−06 | 2.95E−10 | 1.47E−12 | 0.00E+00 | 0.00E+00 |
| 13 | 0.000 | −7.78E−06 | −3.68E−09 | −7.45E−12 | 1.53E−14 | 0.00E+00 |
| 22 | 0.000 | −1.65E−05 | −5.64E−09 | 1.05E−10 | −1.38E−13 | 0.00E+00 |
| 27 | 0.000 | 3.23E−05 | 3.08E−08 | 1.01E−10 | −6.68E−13 | 0.00E+00 |

TABLE 12
Working Example 3

| | Wide Angle | Intermediate | Telephoto |
|---|---|---|---|
| | End | Focal Distance | End |
| f | 16.5 | 23.66 | 33.95 |
| Fno | 2.88 | 2.88 | 2.88 |
| BF | 1.00 | 1.00 | 1.00 |
| ω | 54.03 | 42.18 | 31.7 |

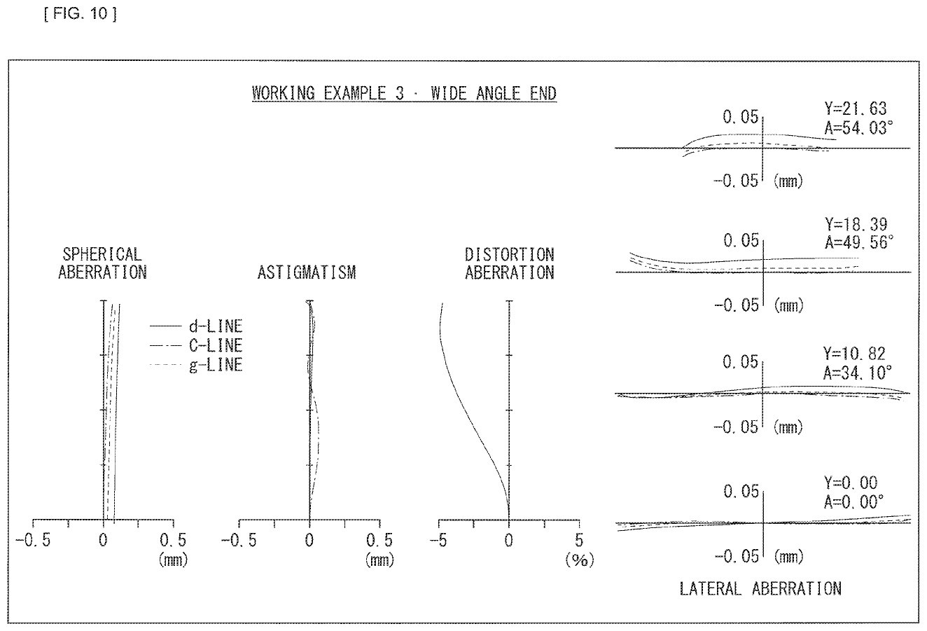

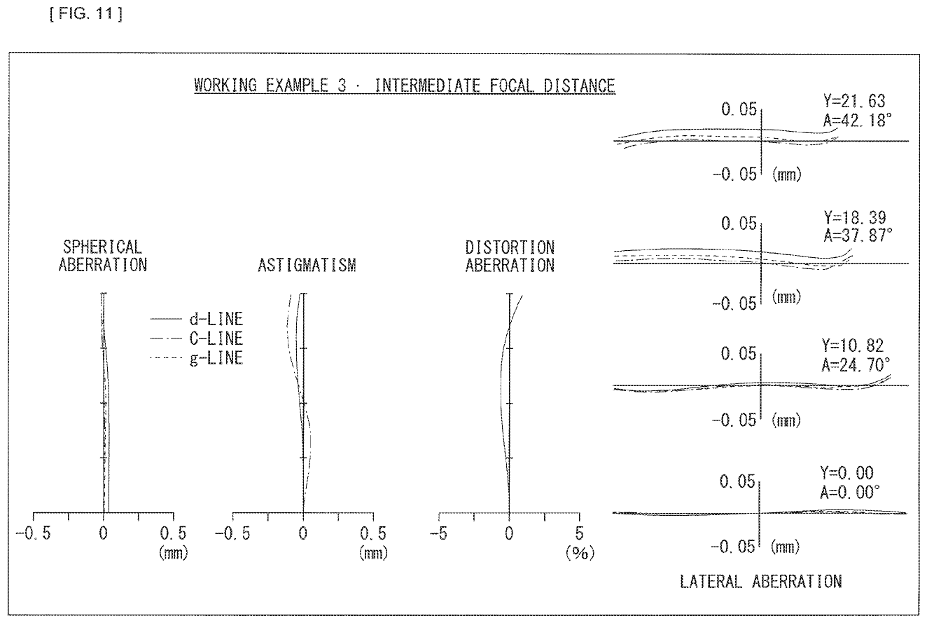

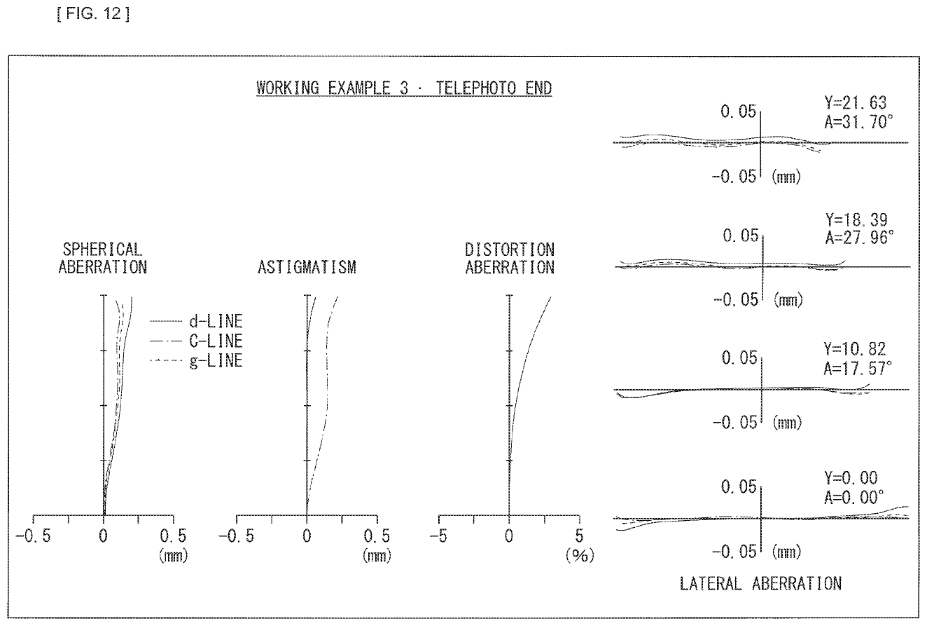

FIG. 10 illustrates various aberrations at a wide angle end in Numerical Working Example 3. FIG. 11 illustrates various aberrations at an intermediate focal distance in Numerical Working Example 3. FIG. 12 illustrates various aberrations at a telephoto end in Numerical Working Example 3.

As can be appreciated from each of the aberration diagrams, each of the aberrations are favorably corrected in a balanced fashion at the wide angle end, at the intermediate focal distance, and at the telephoto end, in Numerical Working Example 3. Hence, it is clear that the zoom lens 3 has a superior image-forming performance.

### Numerical Working Example 4

In the zoom lens 4 illustrated in FIG. 13, the first lens group G1 includes the first lens L1 having a convex shape toward the object side and having negative refractive power, the second lens L2 having a convex shape toward the object side and having negative refractive power, the third lens L3 having a concave shape toward both the sides and having negative refractive power, and the fourth lens L4 having a convex shape toward the object side and having positive refractive power.

The second lens group G2 includes the fifth lens L5 having a convex shape toward both the sides and having positive refractive power.

The third lens group G3 includes the sixth lens L6 having a convex shape toward the image plane side and having negative refractive power and the seventh lens L7 having a convex shape toward both the sides and having positive refractive power.

The fourth lens group G4 includes a cemented lens having positive refractive power in which the eighth lens L8 and the ninth lens L9 are cemented, and the tenth lens L10. The eighth lens L8 has a convex shape toward the object side and has negative refractive power. The ninth lens L9 is disposed on the image plane side of the eighth lens L8, has a convex shape toward the object side, and has positive refractive power. The tenth lens L10 has a convex shape toward both the sides and has positive refractive power.

The fifth lens group G5 includes a cemented lens having negative refractive power in which the eleventh lens L11 and the twelfth lens L12 are cemented, the thirteenth lens L13, a cemented lens having negative refractive power in which the fourteenth lens L14 and the fifteenth lens L15 are cemented, and the sixteenth lens L16. The eleventh lens L11 has a convex shape toward both the sides and has positive refractive power. The twelfth lens L12 is disposed on the image plane side of the eleventh lens L11, has a concave shape toward both the sides, and has negative refractive power. The thirteenth lens L13 has a convex shape toward both the sides and has positive refractive power. The fourteenth lens L14 has a convex shape toward both the sides and has positive refractive power. The fifteenth lens L15 is disposed on the image plane side of the fourteenth lens L14, has a concave shape toward both the sides, and has negative refractive power. The sixteenth lens L16 has a concave shape toward both the sides and has negative refractive power.

The aperture stop S is disposed between the third lens group G3 and the fourth lens group G4. The image plane IP is disposed on the image plane side of the fifth lens group G5. The cover glass CG is disposed between the fifth lens group G5 and the image plane IP.

[Table 13] lists basic lens data of Numerical Working Example 4 in which specific numerical values are applied to the zoom lens 4. In [Table 13], intervals that are variable upon zooming are referred to as D(1), D(2), D(3), D(4), and D(5). Values of these variable intervals are listed in [Table 14].

In the zoom lens 4, an aspherical surface is formed on each of a surface (a first surface) on the object side and a surface (a second surface) on the image plane side of the first lens L1, a surface (a fifth surface) on the image plane side of the second lens L2, and a surface (a fourteenth surface) on the object side and surface (a fifteenth surface) on the image plane side of the seventh lens L7. Further, an aspherical surface is formed on each of a surface (a twenty-first surface) on the image plane side of the tenth lens L10 and a surface (a thirtieth surface) on the object side of the sixteenth lens L16. In particular, the second lens L2 is a hybrid lens (a compound aspherical surface). Values of fourth, sixth, eighth, tenth, and twelfth degree aspherical coefficients A4, A6, A8, A10, and A12 of each of the aspherical surfaces in Numerical Working Example 4 are listed, together with the conic coefficient K, in [Table 15].

Further, [Table 16] lists values of the focal distance f of the total system, the F number (Fno), the backfocus BF, and the half angle of view w upon the infinity focusing in the zoom lens 4.

TABLE 13
Working Example 4

| Surface No. | Ri | Di | Ndi | νdi |
|---|---|---|---|---|
| 1(ASP) | 351.608 | 2.800 | 1.768015 | 49.2 |
| 2(ASP) | 27.110 | 6.265 | | |
| 3 | 38.181 | 1.860 | 1.834805 | 42.7 |
| 4 | 26.000 | 0.150 | 1.534200 | 41.7 |
| 5(ASP) | 26.420 | 10.240 | | |
| 6 | −101.224 | 1.800 | 1.772500 | 49.6 |
| 7 | 52.228 | 0.400 | | |
| 8 | 52.162 | 4.022 | 1.912366 | 21.9 |
| 9 | 236.214 | D(1) | | |
| 10 | 104.610 | 3.850 | 1.658436 | 50.9 |
| 11 | −74.272 | D(2) | | |
| 12 | −48.000 | 1.100 | 1.834287 | 39.1 |
| 13 | −161.271 | 0.400 | | |
| 14(ASP) | 41.935 | 4.058 | 1.583130 | 59.5 |
| 15(ASP) | −726.966 | 3.100 | | |
| 16(IRIS) | INF | D(3) | | |
| 17 | 34.858 | 1.600 | 1.723417 | 38.0 |
| 18 | 22.030 | 6.543 | 1.487489 | 70.4 |
| 19 | 103.207 | 0.400 | | |
| 20 | 79.712 | 4.173 | 1.693500 | 53.2 |
| 21(ASP) | −65.576 | D(4) | | |
| 22 | 131.010 | 5.174 | 1.550084 | 75.5 |
| 23 | −25.597 | 1.500 | 1.901747 | 34.6 |
| 24 | 90.717 | 0.400 | | |
| 25 | 29.497 | 6.118 | 1.969970 | 81.6 |
| 26 | −36.964 | 0.400 | | |
| 27 | 156.819 | 4.720 | 1.922860 | 20.9 |
| 28 | −26.738 | 1.000 | 1.903658 | 31.3 |
| 29 | 47.217 | 2.811 | | |
| 30(ASP) | −1106.462 | 1.500 | 1.882023 | 37.2 |
| 31 | 75.000 | D(5) | | |
| 32 | INF | 2.500 | 1.516798 | 64.2 |
| 33 | INF | BF | | |

TABLE 14
Working Example 4

| Variable | Wide Angle | Intermediate | |
|---|---|---|---|
| Interval | End | Focal Distance | Telephoto End |
| D(1) | 21.06 | 9.43 | 3.70 |
| D(2) | 20.76 | 19.16 | 8.82 |
| D(3) | 10.91 | 5.38 | 2.50 |
| D(4) | 4.49 | 6.96 | 9.35 |
| D(5) | 17.42 | 25.20 | 35.83 |

TABLE 15
Working Example 4

| Surface No. | K | A4 | A6 | A8 | A10 | A12 |
|---|---|---|---|---|---|---|
| 1 | 1.000 | 1.68E−05 | −2.85E−08 | 2.87E−11 | −1.66E−14 | 4.23E−18 |
| 2 | 0.205 | 1.13E−05 | 6.52E−09 | −2.52E−11 | −5.69E−14 | 0.00E+00 |
| 5 | −0.810 | 9.84E−06 | −2.71E−08 | 5.12E−11 | 8.45E−14 | 0.00E+00 |
| 14 | 0.000 | −5.38E−06 | −7.41E−09 | 0.00E+00 | 0.00E+00 | 0.00E+00 |
| 15 | 0.000 | −2.09E−06 | −7.10E−09 | 1.14E−12 | 0.00E+00 | 0.00E+00 |
| 21 | 0.000 | 3.62E−06 | −3.59E−09 | −3.40E−12 | 0.00E+00 | 0.00E+00 |
| 30 | 0.000 | −2.77E−05 | −3.94E−08 | −2.35E−10 | 0.00E+00 | 0.00E+00 |

TABLE 16
Working Example 4

| | Wide Angle | Intermediate | Telephoto |
|---|---|---|---|
| | End | Focal Distance | End |
| f | 16.5 | 22.91 | 33.95 |
| Fno | 2.88 | 2.88 | 2.88 |
| BF | 1.00 | 1.00 | 1.00 |
| ω | 53.95 | 43.14 | 31.71 |

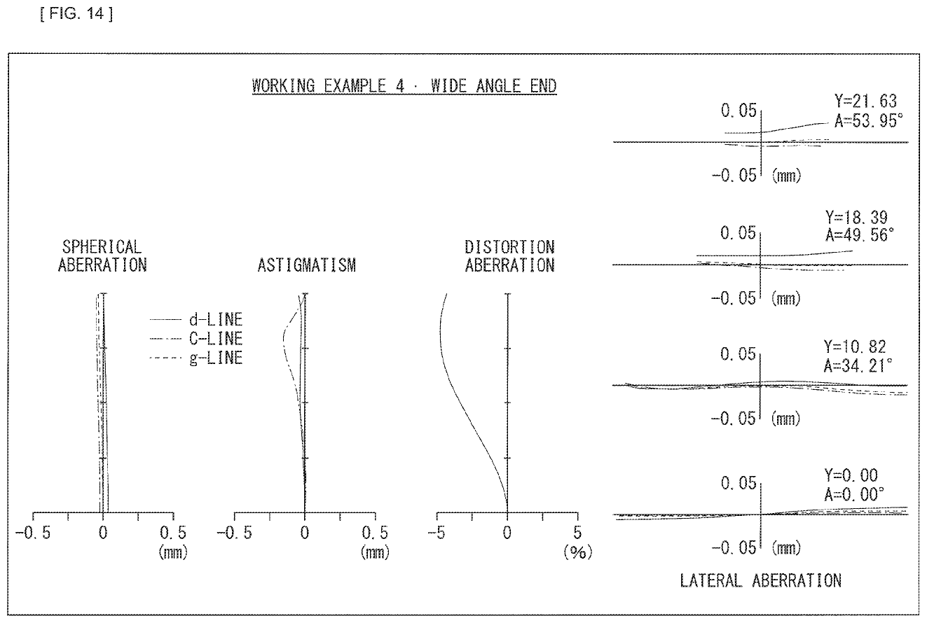

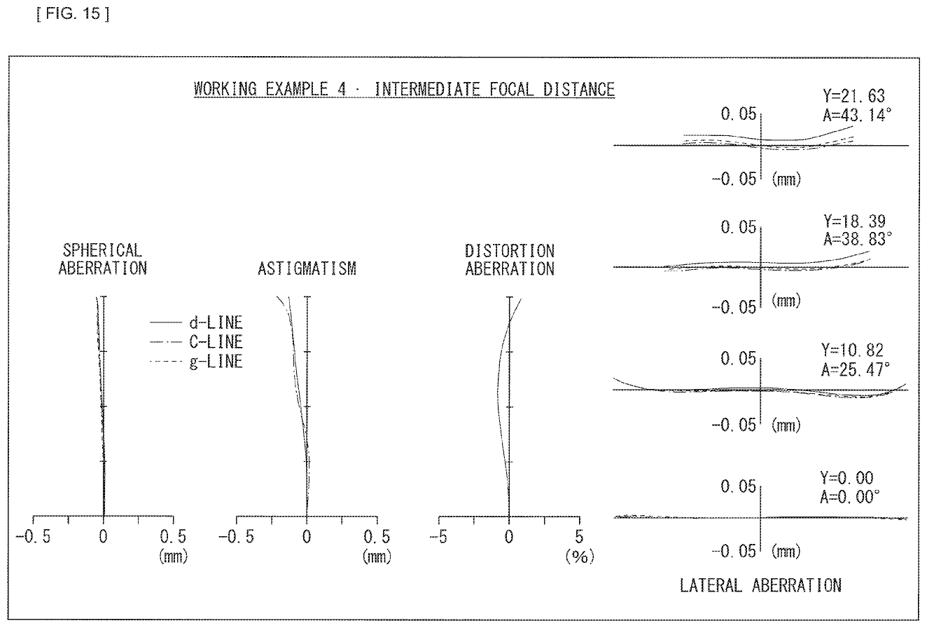

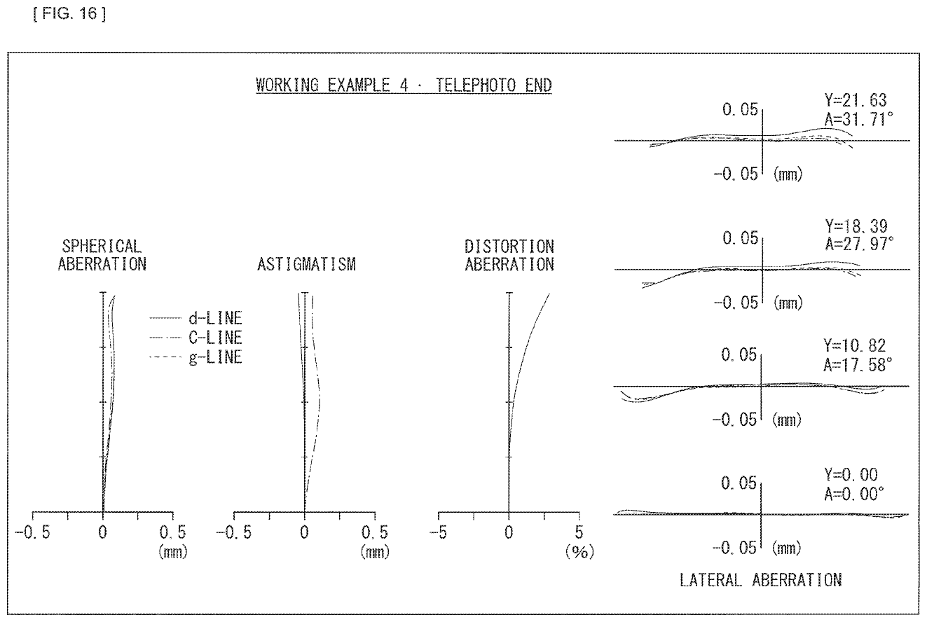

FIG. 14 illustrates various aberrations at a wide angle end in Numerical Working Example 4. FIG. 15 illustrates various aberrations at an intermediate focal distance in Numerical Working Example 4. FIG. 16 illustrates various aberrations at a telephoto end in Numerical Working Example 4.

As can be appreciated from each of the aberration diagrams, each of the aberrations are favorably corrected in a balanced fashion at the wide angle end, at the intermediate focal distance, and at the telephoto end, in Numerical Working Example 4. Hence, it is clear that the zoom lens 4 has a superior image-forming performance.

### Numerical Working Example 5

In the zoom lens 5 illustrated in FIG. 17, the first lens group G1 includes the first lens L1, the second lens L2, and a cemented lens having negative refractive power in which the third lens L3 and the fourth lens L4 are cemented. The first lens L1 has a convex shape toward the object side and has negative refractive power. The second lens L2 has a convex shape toward the object side and has negative refractive power. The third lens L3 has a concave shape toward both the sides and has negative refractive power. The fourth lens L4 is disposed on the image plane side of the third lens L3, has a convex shape toward the object side, and has positive refractive power.

The second lens group G2 includes the fifth lens L5 having a convex shape toward both the sides and having positive refractive power.

The third lens group G3 includes the sixth lens L6 having a convex shape toward the image plane side and having negative refractive power and the seventh lens L7 having a convex shape toward both the sides and having positive refractive power.

The fourth lens group G4 includes a cemented lens having positive refractive power in which the eighth lens L8 and the ninth lens L9 are cemented, and the tenth lens L10. The eighth lens L8 has a convex shape toward the object side and has negative refractive power. The ninth lens L9 is disposed on the image plane side of the eighth lens L8, has a convex shape toward both the sides, and has positive refractive power. The tenth lens L10 has a convex shape toward both the sides and has positive refractive power.

The fifth lens group G5 includes a cemented lens having negative refractive power in which the eleventh lens L11 and the twelfth lens L12 are cemented, the thirteenth lens L13, a cemented lens having negative refractive power in which the fourteenth lens L14 and the fifteenth lens L15 are cemented, and the sixteenth lens L16. The eleventh lens L11 has a convex shape toward both the sides and has positive refractive power. The twelfth lens L12 is disposed on the image plane side of the eleventh lens L11, has a concave shape toward both the sides, and has negative refractive power. The thirteenth lens L13 has a convex shape toward both the sides and has positive refractive power. The fourteenth lens L14 has a convex shape toward the image plane side and has positive refractive power. The fifteenth lens L15 is disposed on the image plane side of the fourteenth lens L14, has a concave shape toward both the sides, and has negative refractive power. The sixteenth lens L16 has a concave shape toward both the sides and has negative refractive power.

The aperture stop S is disposed between the third lens group G3 and the fourth lens group G4. The image plane IP is disposed on the image plane side of the fifth lens group G5. The cover glass CG is disposed between the fifth lens group G5 and the image plane IP.

[Table 17] lists basic lens data of Numerical Working Example 5 in which specific numerical values are applied to the zoom lens 5. In [Table 17], intervals that are variable upon zooming are referred to as D(1), D(2), D(3), D(4), and D(5). Values of these variable intervals are listed in [Table 18].

In the zoom lens 5, an aspherical surface is formed on each of a surface (a first surface) on the object side and a surface (a second surface) on the image plane side of the first lens L1, a surface (a fifth surface) on the image plane side of the second lens L2, and a surface (a thirteenth surface) on the object side and surface (a fourteenth surface) on the image plane side of the seventh lens L7. Further, an aspherical surface is formed on each of a surface (a twenty-third surface) on the image plane side of the twelfth lens L12, and a surface (a twenty-ninth surface) on the object side and a surface (thirtieth surface) on the image plane side of the sixteenth lens L16. Values of fourth, sixth, eighth, tenth, and twelfth degree aspherical coefficients A4, A6, A8, A10, and A12 of each of the aspherical surfaces in Numerical Working Example 5 are listed, together with the conic coefficient K, in [Table 19].

Further, [Table 20] lists values of the focal distance f of the total system, the F number (Fno), the backfocus BF, and the half angle of view w upon the infinity focusing in the zoom lens 5.

TABLE 17
Working Example 5

| Surface No. | Ri | Di | Ndi | νdi |
|---|---|---|---|---|
| 1(ASP) | 272.884 | 2.800 | 1.768015 | 49.2 |
| 2(ASP) | 24.243 | 7.801 | | |
| 3 | 44.614 | 1.860 | 1.834805 | 42.7 |
| 4 | 26.000 | 0.150 | 1.534200 | 41.7 |
| 5(ASP) | 27.973 | 8.733 | | |
| 6 | −140.452 | 1.800 | 1.589129 | 61.3 |
| 7 | 37.856 | 4.301 | 1.921189 | 24.0 |
| 8 | 105.595 | D(1) | | |
| 9 | 92.768 | 3.850 | 1.658436 | 50.9 |
| 10 | −71.360 | D(2) | | |
| 11 | −51.004 | 1.100 | 1.834000 | 37.3 |
| 12 | −256.610 | 0.400 | | |
| 13(ASP) | 44.544 | 4.152 | 1.583130 | 59.5 |
| 14(ASP) | −365.000 | 3.100 | | |
| 15(IRIS) | INF | D(3) | | |
| 16 | 42.894 | 1.600 | 1.755200 | 27.5 |
| 17 | 30.856 | 6.057 | 1.487489 | 70.4 |
| 18 | −369.008 | 0.400 | | |
| 19 | 81.503 | 4.041 | 1.592824 | 68.6 |
| 20 | −81.507 | D(4) | | |
| 21 | 253.797 | 5.772 | 1.496997 | 81.6 |
| 22 | −20.500 | 1.500 | 1.851348 | 40.1 |
| 23(ASP) | 162.833 | 0.400 | | |
| 24 | 35.804 | 7.535 | 1.496997 | 81.6 |
| 25 | −22.646 | 0.400 | | |
| 26 | −152.083 | 4.827 | 1.922860 | 20.9 |
| 27 | −21.067 | 1.000 | 1.903658 | 31.3 |
| 28 | 1133.115 | 2.570 | | |
| 29(ASP) | −41.536 | 1.500 | 1.851348 | 40.1 |
| 30(ASP) | 300.000 | D(5) | | |
| 31 | INF | 2.500 | 1.516798 | 64.2 |
| 32 | INF | BF | | |

TABLE 18
Working Example 5

| Variable | Wide Angle | Intermediate | |
|---|---|---|---|
| Interval | End | Focal Distance | Telephoto End |
| D(1) | 22.47 | 11.18 | 3.70 |
| D(2) | 15.47 | 13.61 | 8.49 |
| D(3) | 9.97 | 5.96 | 2.50 |
| D(4) | 4.57 | 6.56 | 9.12 |
| D(5) | 15.89 | 23.61 | 35.10 |

TABLE 19
Working Example 5

| Surface No. | K | A4 | A6 | A8 | A10 | A12 |
|---|---|---|---|---|---|---|
| 1 | −0.900 | 1.56E−05 | −2.85E−08 | 3.31E−11 | −2.24E−14 | 6.71E−18 |
| 2 | −0.060 | 6.58E−06 | 1.26E−08 | −5.65E−11 | 9.74E−15 | 0.00E+00 |
| 5 | −0.879 | 1.73E−05 | −4.92E−08 | 1.70E−10 | −1.53E−13 | 0.00E+00 |
| 13 | 0.000 | −4.81E−06 | −9.89E−09 | 0.00E+00 | 0.00E+00 | 0.00E+00 |
| 14 | 0.000 | −1.91E−06 | −8.47E−09 | 2.39E−13 | 0.00E+00 | 0.00E+00 |
| 23 | 0.000 | 8.50E−06 | 1.70E−08 | 8.37E−11 | 0.00E+00 | 0.00E+00 |
| 29 | 0.000 | −8.40E−06 | −7.10E−09 | 1.23E−10 | 0.00E+00 | 0.00E+00 |
| 30 | 0.000 | 1.54E−05 | 1.71E−08 | 2.70E−11 | 0.00E+00 | 0.00E+00 |

TABLE 20
Working Example 5

| | Wide Angle | Intermediate | Telephoto |
|---|---|---|---|
| | End | Focal Distance | End |
| f | 16.5 | 22.9 | 33.95 |
| Fno | 2.88 | 2.88 | 2.88 |
| BF | 1.00 | 1.00 | 1.00 |
| ω | 53.95 | 43.23 | 31.71 |

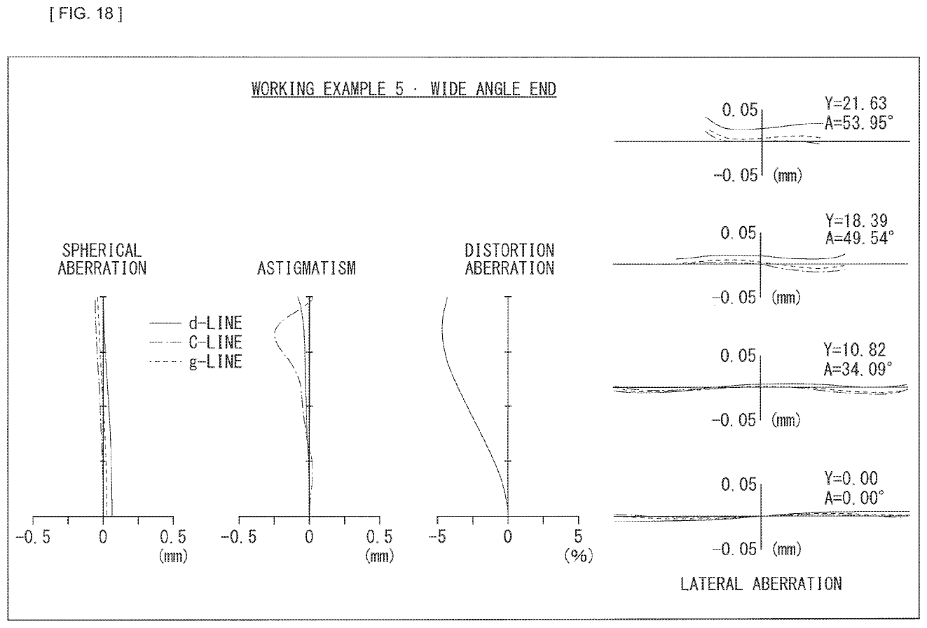

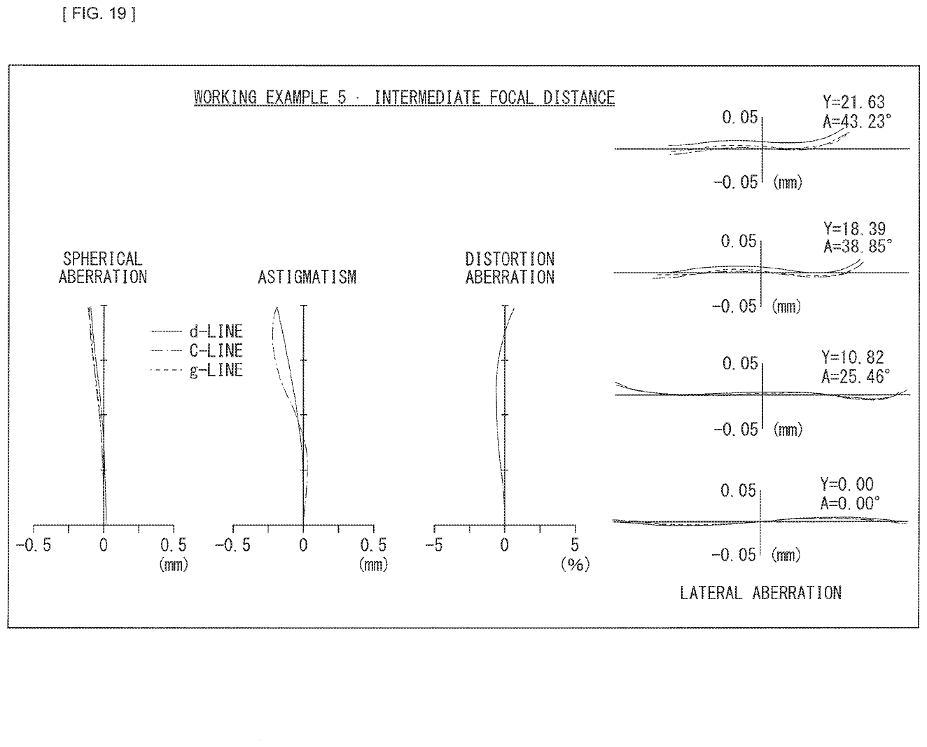

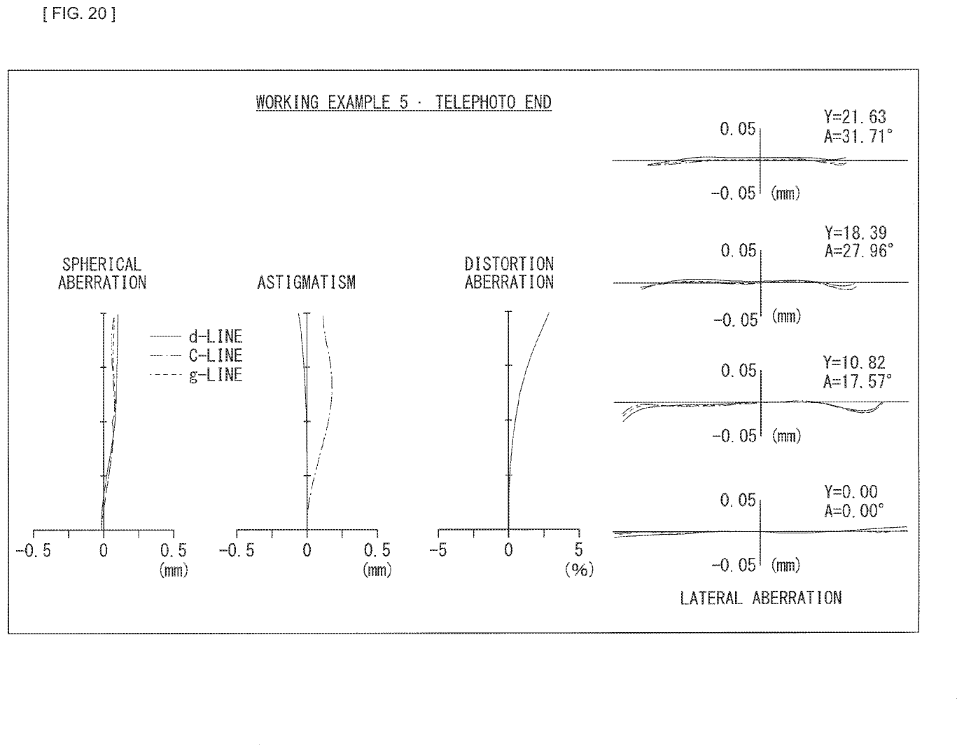

FIG. 18 illustrates various aberrations at a wide angle end in Numerical Working Example 5. FIG. 19 illustrates various aberrations at an intermediate focal distance in Numerical Working Example 5. FIG. 20 illustrates various aberrations at a telephoto end in Numerical Working Example 5.

As can be appreciated from each of the aberration diagrams, each of the aberrations are favorably corrected in a balanced fashion at the wide angle end, at the intermediate focal distance, and at the telephoto end, in Numerical Working Example 5. Hence, it is clear that the zoom lens 5 has a superior image-forming performance.

### Other Numerical Data of Each Working Example

[Table 21] and [Table 22] summarize values related to the above-described conditional expressions for each of the Numerical Working Examples. As can be appreciated from [Table 21], the values of each of the Numerical Working Examples fall within the numerical ranges of the respective conditional expressions.

TABLE 21

| Conditional | | Working | Working | Working | Working | Working |
|---|---|---|---|---|---|---|
| Expression | | Example 1 | Example 2 | Example 3 | Example 4 | Example 5 |
| (1) | \|2G/4G\| | 1.19 | 1.43 | 0.78 | 1.56 | 1.46 |
| (2) | t_2β/w_2β | −0.15 | 0.34 | 0.28 | 0.38 | 0.16 |
| (3) | 2G/(fw · ft)^{1/2} | 2.34 | 2.62 | 2.86 | 2.81 | 2.60 |
| (4) | \|4G/5G\| | 0.40 | 0.47 | 1.47 | 0.53 | 0.53 |

TABLE 22

| | Working | Working | Working | Working | Working |
|---|---|---|---|---|---|
| | Example 1 | Example 2 | Example 3 | Example 4 | Example 5 |
| 2G | 55.30 | 62.06 | 67.60 | 66.53 | 61.55 |
| 4G | 46.42 | 43.29 | −86.60 | 42.63 | 42.07 |
| t_2β | 3.34 | 2.46 | 2.49 | 2.38 | 2.76 |
| w_2β | −22.14 | 7.26 | 9.01 | 6.31 | 17.61 |
| fw | 16.48 | 16.48 | 16.48 | 16.48 | 16.48 |
| ft | 33.95 | 33.95 | 33.95 | 33.95 | 33.95 |
| 5G | −115.78 | −91.59 | −59.05 | −80.40 | −78.86 |

### 5. Other Embodiments

A technique of the present disclosure is not limited to the description of the above-described embodiments and Working Examples, and may be modified and worked in a variety of ways.

For example, shapes and the numerical values of respective portions illustrated in each of the above-described Numerical Working Examples are each merely one embodying example to work the technology. Accordingly, a technical scope of the technology should not be construed in a limiting fashion by those shapes and numerical values.

Further, although the above-described embodiments and Working Examples have been described with reference to the configuration that substantially includes the five lens groups, a configuration may be employed that further includes a lens that does not have refractive power substantially.

Moreover, for example, the technology may have the following configurations.

[1]

A zoom lens including, in order from an object side toward an image plane side:

a first lens group having negative refractive power;

a second lens group having positive refractive power;

a third lens group having positive refractive power;

a fourth lens group having positive or negative refractive power; and

a fifth lens group having negative refractive power, in which

intervals between the respective lens groups are changed upon zooming from a wide angle end to a telephoto end, and

focusing is performed by causing the second lens group and the fourth lens group to travel upon changing of a subject distance from infinity to proximity.

[2]

The zoom lens according to [1], in which the following conditional expression is further satisfied:

0.5<|2G/4G|<2.0 (1)

where

2G denotes a focal distance of the second lens group, and

4G denotes a focal distance of the fourth lens group.

[3]

The zoom lens according to [1] or [2], in which the following conditional expression is further satisfied:

−0.5<t_2β/w_2β<0.6 (2)

where

t_2β denotes a lateral magnification of the second lens group at the telephoto end, and

w_2β denotes a lateral magnification of the second lens group at the wide angle end.

[4]

The zoom lens according to any one of [1] to [3], in which the following conditional expression is further satisfied:

2.1<2G/(fw·ft)^{1/2}<3.0 (3)

where

2G denotes the focal distance of the second lens group G2,

fw denotes a focal distance of a total system at the wide angle end, and

ft denotes a focal distance of the total system at the telephoto end.

[5]

The zoom lens according to any one of [1] to [4], in which the following conditional expression is further satisfied:

0.3<|4G/5G|<1.6 (4)

where

4G denotes the focal distance of the fourth lens group, and

5G denotes a focal distance of the fifth lens group.

[6]

The zoom lens according to any one of [1] to [5], in which the first lens group includes one or more aspherical lenses.

[7]

The zoom lens according to any one of [1] to [6], in which the fifth lens group includes one or more cemented lenses.

[8]

The zoom lens according to any one of [1] to [7], in which the second lens group to the fifth lens group are positioned, upon the zooming, on the object side at the telephoto end as compared with the wide angle end.

[9]

An imaging apparatus including:

a zoom lens; and

an imaging device that outputs an imaging signal corresponding to an optical image formed by the zoom lens,

the zoom lens including, in order from an object side toward an image plane side
a first lens group having negative refractive power,
a second lens group having positive refractive power,
a third lens group having positive refractive power,
a fourth lens group having positive or negative refractive power, and
a fifth lens group having negative refractive power, in which

intervals between the respective lens groups are changed upon zooming from a wide angle end to a telephoto end, and

focusing is performed by causing the second lens group and the fourth lens group to travel upon changing of a subject distance from infinity to proximity.

[10]

The imaging apparatus according to [9], in which the following conditional expression is further satisfied:

0.5<|2G/4G|<2.0 (1)

where

2G denotes a focal distance of the second lens group, and

4G denotes a focal distance of the fourth lens group.

[11]

The imaging apparatus according to [9] or [10], in which the following conditional expression is further satisfied:

−0.5<t_2β/w_2β<0.6 (2)

where

t_2β denotes a lateral magnification of the second lens group at the telephoto end, and

w_2β denotes a lateral magnification of the second lens group at the wide angle end.

[12]

The imaging apparatus according to any one of [9] to [11], in which the following conditional expression is further satisfied:

2.1<2G/(fw·ft)^{1/2}<3.0 (3)

where

2G denotes the focal distance of the second lens group G2,

fw denotes a focal distance of a total system at the wide angle end, and

ft denotes a focal distance of the total system at the telephoto end.

[13]

The imaging apparatus according to any one of [9] to [12], in which the following conditional expression is further satisfied:

0.3<|4G/5G|<1.6 (4)

where

4G denotes the focal distance of the fourth lens group, and

5G denotes a focal distance of the fifth lens group.

[14]

The imaging apparatus according to any one of [9] to [13], in which the first lens group includes one or more aspherical lenses.

[15]

The imaging apparatus according to any one of [9] to [14], in which the fifth lens group includes one or more cemented lenses.

[16]

The imaging apparatus according to any one of [9] to [15], in which the second lens group to the fifth lens group are positioned, upon the zooming, on the object side at the telephoto end as compared with the wide angle end.

[17]

The zoom lens according to any one of [1] to [8], further including a lens not substantially having refractive power.

[18]

The imaging apparatus according to any one of [9] to [16], in which the zoom lens further includes a lens not substantially having refractive power.

This application claims the priority of Japanese Priority Patent Application JP2017-011423 filed with the Japan Patent Office on Jan. 25, 2017, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. A zoom lens comprising, in order from an object side toward an image plane side:
a first lens group having negative refractive power;
a second lens group having positive refractive power;
a third lens group having positive refractive power;
a fourth lens group having positive or negative refractive power; and
a fifth lens group having negative refractive power, wherein
intervals between the respective lens groups are changed upon zooming from a wide angle end to a telephoto end, and
focusing is performed by causing the second lens group and the fourth lens group to travel upon changing of a subject distance from infinity to proximity.

2. The zoom lens according to claim 1, wherein the following conditional expression is further satisfied:
0.5<|2G/4G|<2.0 (1)
where
2G denotes a focal distance of the second lens group, and
4G denotes a focal distance of the fourth lens group.

3. The zoom lens according to claim 1, wherein the following conditional expression is further satisfied:
−0.5<t_2β/w_2β<0.6 (2)
where
t_2β denotes a lateral magnification of the second lens group at the telephoto end, and
w_2β denotes a lateral magnification of the second lens group at the wide angle end.

4. The zoom lens according to claim 1, wherein the following conditional expression is further satisfied:
2.1<2G/(fw·ft)^{1/2}<3.0 (3)
where
2G denotes a focal distance of the second lens group G2,
fw denotes a focal distance of a total system at the wide angle end, and
ft denotes a focal distance of the total system at the telephoto end.

5. The zoom lens according to claim 1, wherein the following conditional expression is further satisfied:
0.3<|4G/5G|<1.6 (4)
where
4G denotes a focal distance of the fourth lens group, and
5G denotes a focal distance of the fifth lens group.

6. The zoom lens according to claim 1, wherein the first lens group includes one or more aspherical lenses.

7. The zoom lens according to claim 1, wherein the fifth lens group includes one or more cemented lenses.

8. The zoom lens according to claim 1, wherein the second lens group to the fifth lens group are positioned, upon the zooming, on the object side at the telephoto end as compared with the wide angle end.

9. An imaging apparatus comprising:
a zoom lens; and
an imaging device that outputs an imaging signal corresponding to an optical image formed by the zoom lens,
the zoom lens including, in order from an object side toward an image plane side
a first lens group having negative refractive power,
a second lens group having positive refractive power,
a third lens group having positive refractive power,
a fourth lens group having positive or negative refractive power, and
a fifth lens group having negative refractive power, wherein
intervals between the respective lens groups are changed upon zooming from a wide angle end to a telephoto end, and
focusing is performed by causing the second lens group and the fourth lens group to travel upon changing of a subject distance from infinity to proximity.

10. The imaging apparatus according to claim 9, wherein the following conditional expression is further satisfied:
0.5<|2G/4G|<2.0 (1)
where
2G denotes a focal distance of the second lens group, and
4G denotes a focal distance of the fourth lens group.

11. The imaging apparatus according to claim 9, wherein the following conditional expression is further satisfied:
—0.5<t_2β/w_2β<0.6 (2)
where
t_2β denotes a lateral magnification of the second lens group at the telephoto end, and
w_2β denotes a lateral magnification of the second lens group at the wide angle end.

12. The imaging apparatus according to claim 9, wherein the following conditional expression is further satisfied:
2.1<2G/(fw·ft)^{1/2}<3.0 (3)
where
2G denotes a focal distance of the second lens group G2,
fw denotes a focal distance of a total system at the wide angle end, and
ft denotes a focal distance of the total system at the telephoto end.

13. The imaging apparatus according to claim 9, wherein the following conditional expression is further satisfied:
0.3<|4G/5G|<1.6 (4)
where
4G denotes a focal distance of the fourth lens group, and
5G denotes a focal distance of the fifth lens group.

14. The imaging apparatus according to claim 9, wherein the first lens group includes one or more aspherical lenses.

15. The imaging apparatus according to claim 9, wherein the fifth lens group includes one or more cemented lenses.

16. The imaging apparatus according to claim 9, wherein the second lens group to the fifth lens group are positioned, upon the zooming, on the object side at the telephoto end as compared with the wide angle end.
